(19) United States
(12) Patent Application Publication
(10) Pub. No.: US 2025/0041154 A1
(43) Pub. Date: Feb. 6, 2025

(54) MASSAGER

(71) Applicant: Dongguan Lingding Technology Co., Ltd, Dongguan (CN)

(72) Inventor: Kui JI, Shenzhen (CN)

(73) Assignee: Dongguan Lingding Technology Co., Ltd, Dongguan (CN)

(21) Appl. No.: 18/456,740

(22) Filed: Aug. 28, 2023

(30) Foreign Application Priority Data
Aug. 5, 2023 (CN) 202322093931.8

(51) Int. Cl. A61H 23/02

(52) U.S. Cl. CPC A61H 23/0254; A61H 2201/0153; A61H 2201/0165; A61H 2201/0188; A61H 2201/5058

(57) ABSTRACT

A massage device includes a massage head having at least one massage surface and an assembly space; a mounting bracket mounted in the assembly space and fixed to the massage head; an electric motor and an eccentric member arranged in the assembly space and located on opposite sides of the mounting bracket; and a balancing member located on the same side of the mounting bracket as the electric motor. The electric motor includes a stator, a rotor, and an output shaft; the stator is fixed to the mounting bracket, the rotor is rotatable relative to the stator, and the output shaft is fixed to the rotor and is rotatably connected to the mounting bracket. The eccentric member is fixed to the output shaft to rotate eccentrically with the output shaft, and the balancing member is connected to the rotor or the output shaft.

### CROSS-REFERENCE TO RELATED APPLICATIONS

This application claims priority to Chinese Patent Application No. 202322093931.8, filed on Aug. 5, 2023, the content of which is incorporated herein by reference in its entirety.

### TECHNICAL FIELD

The present invention relates to the technical field of massage, in particular to a massage device.

### BACKGROUND

With the improvement of people's living standards, people's attention to physical health is increasing. In order to meet people's needs, a high-frequency vibration massage device has been developed. During the vibration process of the massage device, due to the mismatch between a weight of a vibrating part and a weight of a motor part, the vibrating part performs a deflected a circular movement during operation, resulting in a large amount of energy being used for the deflection. This greatly reduces the energy transmitted to a massage head of the massage device and thus greatly reduces the energy utilization rate, and making the energy efficiency of the massage device very low.

It is worth noting that the above content is only used to raise technical issues and does not represent existing prior art that is known to one skilled in the art.

### SUMMARY

The present disclosure aims to provide a massage device which can improve the efficiency of the massage device to improve a vibration of the massage device.

To achieve the above objectives, the massage device provided in this application includes:
a massage head having at least one massage surface and an assembly space;
a mounting bracket mounted in the assembly space and fixed to the massage head;
an electric motor and an eccentric member arranged in the assembly space and located on opposite sides of the mounting bracket;
a balancing member located on the same side of the mounting bracket as the electric motor;
where the electric motor includes a stator, a rotor, and an output shaft; wherein the stator is fixed to the mounting bracket, the rotor is rotatable relative to the stator; the output shaft is fixed to the rotor and is rotatably connected to the mounting bracket;
the eccentric member is fixed to the output shaft to rotate eccentrically with the output shaft, and is configured to convert a rotation output by the electric motor into a vibration of the massage head;
the balancing member is connected to the rotor or the output shaft such that the balancing member can rotate with the rotor or the output shaft; and the balancing member is configured to increase a weight of either the rotor or an end of the output shaft away from the eccentric member to balance two sides of the mounting bracket, such that the eccentric member, the output shaft, the rotor, and the balancing member can respectively perform a balanced circular rotation to prevent any deflection of the two ends of the output shaft.

In some embodiments, the mounting bracket is located in an assembly chamber defined in the assembly space along a radial direction of the output shaft to divide the assembly chamber into a first chamber and a second chamber arranged along an axial direction of the output shaft; the eccentric member is located in the first chamber, and the stator, the rotor, and the balancing member are located in the second chamber, and the output shaft extends from the second chamber into the first chamber; the mounting bracket is plate-shaped, and both the eccentric member and the balancing member are symmetrical about the mounting bracket.

In some embodiments, the electric motor is an inner rotor motor having an inner rotor, and the balancing member is arranged on the inner rotor; and/or, one end of the output shaft away from the eccentric member extends out of the stator and the rotor, and the balancing member is arranged on the end of the output shaft away from the eccentric member.

In some embodiments, the electric motor is an outer rotor motor having an outer rotor, the outer rotor includes a rotary cylinder having an annular sidewall and an end wall arranged on one end of the sidewall, and the balancing member is arranged on the sidewall and/or the end wall; the stator is located in the rotary cylinder and is fixed to the mounting bracket.

In some embodiments, a weight ratio of the eccentric member to the balancing member ranges from 3:1 to 6:1; and/or, a weight of the eccentric member ranges from 11 g to 45 g, and a weight of the balancing member ranges from 4 g to 11 g; a ratio of a distance between an outer edge of the eccentric member and the output shaft to a distance between an outer edge of the balancing member and the output shaft ranges from 0.8 to 1.2; and/or, the distance between the outer edge of the eccentric member and the output shaft ranges from 16 mm to 26 mm, and similarly, the distance between the outer edge of the balancing member and the output shaft also ranges from 16 mm to 26 mm.

In some embodiments, the distance between the outer edge of the eccentric member and the output shaft is substantially equal to the distance between the outer edge of the balancing member and the output shaft.

In some embodiments, both the eccentric member and the balancing member are located on the same side of the output shaft; and/or the mounting bracket is plate-shaped, and the eccentric member and the balancing member are symmetrical about the mounting bracket; and/or the massage head vibrates at a frequency ranging from 65 Hz to 200 Hz; and/or when the massage head vibrates, the massage surface moves along a first moving track approximately circular and substantially parallel with a radial direction of the massage head; and/or the massage surface moves along a second moving track approximately circular and substantially parallel with an axial direction of the massage head.

In some embodiments, the eccentric member includes a first symmetrical plane in parallel with the output shaft, the balancing member includes a second symmetrical plane in parallel with the output shaft, and an angle formed between the first symmetrical plane and the second symmetrical planes is less than 10°.

In some embodiments, the first symmetrical plane and the second symmetrical coincide.

In some embodiments, the massage head includes a shell portion and a massage portion arranged on an outer sidewall of the shell, the massage portion has the massage surface; the shell portion forms the assembly space, and the mounting bracket is fixed to an inner sidewall of the assembly space corresponding to the massage portion.

In some embodiments, the massage device includes multiple massage portions arranged on the massage head at intervals around a circumferential direction of the shell portion; the mounting bracket includes a bracket body and several mounting portions, the mounting portions are arranged at intervals along a circumferential direction of the bracket body, and the mounting portions are connected to the shell at positions corresponding to the massage portions.

In some embodiments, the massage device further includes a first bearing arranged between the output shaft and the mounting bracket for connecting the output shaft and the mounting bracket; and/or, the first bearing is arranged between the output shaft and the motor bracket for connecting the output shaft and the motor bracket; and/or the massage device further includes a second bearing arranged between one end of the output shaft away from the eccentric member and the stator to rotatably connect the output shaft and the stator; and the end of the output shaft away from the eccentric member is fixed to the stator.

In some embodiments, the massage head includes a shell portion with the assembly space; the shell portion includes an opened end and a blocking end corresponding to the opened end; the opened end has an opening communicating with the assembly space, and the blocking end is formed with a wire hole; a wire structure is arranged on an inner wall of the assembly space, one end of the wire structure is adjacent to the wire hole, and the other end thereof extends along a lengthwise direction of the shell portion.

In some embodiments, the massage device further includes a handheld assembly configured to be held by an user; a buffer assembly configured to reduce a vibration transmission between the massage head and the handheld assembly; the buffer assembly being elastic or flexible, one end of the buffer assembly abutting the end of the massage head, the other end thereof being connected to the handheld assembly; a connecting assembly configured to connect the handheld assembly and the massage head to clamp the buffer assembly between the massage head and the handheld assembly; the handheld assembly including at least one strip-shaped connector made of rigid material, one end of the connector directly or indirectly being connected to the handheld assembly, and the other end thereof passing through the buffer assembly to be fixed to the massage head via the buffer assembly.

In some embodiments, the connecting assembly further includes an end cover module, the handheld assembly includes a handheld tube, the end cover module is fixed to an end of the handheld tube; one end of the connector is connected to the massage head, and the other end thereof engaging with the end cover module.

In some embodiments, the end cover module includes a through hole, the connector includes a limiting end and a connecting end; the connecting end is configured to be fixed to the massage head through the through hole; a radial size of the limiting end is larger than that of the through hole; the limiting end is configured to abut the a side of the end cover module facing away from the massage head when the connecting end is fastened to the massage head.

In some embodiments, the end cover module includes an end cover and a buffer column; the end cover is configured to be connected to the handheld tube, the buffer column is mounted on the end cover, and one end of the buffer column abuts the buffer assembly to reduce a vibration transmission between the buffer assembly and the end cover.

In some embodiments, the buffer column includes a first through hole, the buffer column is sleeved on the connector and is tightly engaged with the connector to reduce a vibration transmission between the connector and the end cover.

In some embodiments, the massage device includes multiple connectors and a buffer column is sleeved on each connector; the end cover module further includes a fastener plate abutting one end of the buffer column away from the buffer assembly; a second through hole is defined in the fastener plate at a position corresponding to the buffer column; the connector is connected to the massage head through the first through hole and the second through hole; and the fastener plate is configured to restrict the multiple buffer columns and ends of the multiple connectors away from the massage head.

In some embodiments, the end cover module further includes a limiting block arranged in an area formed by the multiple buffer columns; the limiting block forms a limiting space matched with shapes of the buffer columns such that the limiting block can be attached to outer sidewalls of the buffer columns; and/or the limiting block is located between the end cover and the fastener plate, with one end thereof abutting the fastener plate and the other end thereof abutting the end cover.

In some embodiments, the end cover includes a cover body and a limiting cylinder fixed to the cover body; the limiting cylinder has a third through hole running through a lengthwise direction thereof, and at least a portion of the buffer column is mounted in the third through-hole.

In some embodiments, the buffer column includes two fitting segments located at both ends and an assembly segment located between the two fitting segments; a radial size of the assembly segment is less that of the fitting segment; the limiting cylinder is located in the cover body, and the assembly segment is received in limiting cylinder, and the fitting segment extends out of the cover body.

In some embodiments, the handheld tube is hollow in which a power supply is arranged; the power supply is electrically connected to the electric motor through a conductor; one end of the handheld tube is opened and at least a part of the buffer column is received in the handheld tube; and/or the end cover is threaded to the end of the handheld tube.

In some embodiments, the buffer assembly includes a buffer plate assembly, one end of the buffer plate assembly abuts the end of the massage head, and the other end thereof abuts the connecting assembly; the connecting assembly further includes an end cover module fixed to an end of the handheld assembly; one end of the connector is connected to the massage head, and the other end thereof engages with the end cover module; the buffer plate assembly is clamped between the end cover module and the massage head to reduce a vibration transmission between the massage head and the end cover module.

In some embodiments, one side of the buffer plate assembly facing the massage head includes a first insertion socket, a connecting column is arranged on one end of the massage head facing the buffer plate assembly, and the connecting column is inserted into the first insertion socket; and/or one side of the buffer plate assembly facing the end cover module includes a second insertion socket; the end cover module includes an end cover and a buffer column mounted on the end cover, one end of the buffer column is exposed on the end cover and is inserted into the second insertion socket.

In some embodiments, one side of the buffer plate assembly facing the massage head includes a first insertion socket, a connecting column is arranged on one end of the massage head facing the buffer plate assembly, the connecting column is inserted into the first insertion socket, and one end of the connector is fixed to the connecting column.

In some embodiments, one side of the buffer plate assembly facing the massage head includes a first insertion socket, a connecting column is arranged on one end of the massage head facing the buffer plate assembly, and the connecting column is inserted into the first insertion socket; one side of the buffer plate assembly facing the end cover module includes a second insertion socket; the end cover module includes an end cover and a buffer column mounted on the end cover, one end of the buffer column is exposed on the end cover and is inserted into the second insertion socket; the first insertion socket and the second insertion sockets are coaxial and communicated with each other.

In some embodiments, the buffer assembly further includes a buffer sleeve; the buffer plate assembly includes a partition plate fixed in the buffer sleeve and a first buffer plate arranged on one side of the partition plate facing the massage head; a connecting column is arranged on end of the massage surface facing the first buffer plate, and the connecting column is inserted into the first insertion socket; one side of the massage head facing the first buffer plate is formed with an assembly groove receiving at least a part of the first buffer plate; and/or the buffer plate assembly includes a partition plate fixed in the buffer sleeve and a second buffer plate located one side of the partition plate facing the end cover module; the end cover module includes an end cover and a buffer column mounted on the end cover; one end of the buffer column is exposed on the end cover and is inserted into the second insertion socket.

In some embodiments, the buffer assembly further includes a buffer sleeve having a first end and a second end, and at least a part of the end cover module is received in the buffer sleeve; and/or the first end is sleeved on one end of the massage head adjacent to the buffer assembly; and/or the second end is sleeved on one end of the handheld assembly adjacent to the buffer assembly.

In some embodiments, the buffer assembly includes a partition plate and a second buffer plate located between the partition plate and the end cover module; and a buffer column is arranged on the second buffer plate extending along a thickness direction thereof; one the side of the partition plate facing the second buffer plate includes a first insertion socket, and one end of the buffer column is inserted into this first insertion socket; and/or one side of the end cover module facing the second buffer plate includes a second insertion socket, and one end of the buffer column away from the partition plate is inserted into the second insertion socket.

In some embodiments, the buffer assembly includes a partition plate and a second buffer plate located between the partition plate and the end cover module; and a buffer column is arranged on the second buffer plate extending along a thickness direction thereof; one side of the end cover module facing the second buffer plate includes a second insertion socket, and one end of the buffer column away from the partition plate is inserted into the second insertion socket; the first insertion socket runs through the partition plate, the second insertion socket runs through the end cover module, and the buffer column includes a first through hole extending along a lengthwise direction thereof, the connector passes through the first through hole, the first insertion socket, and the second insertion socket to be fixed to the massage head, to reduce a vibration transmission between the connector, the end cover, and the partition plate.

In some embodiments, the buffer assembly includes a first buffer plate located between the partition plate and the massage head, both the first buffer plate and the second buffer plate are soft rubber plates, and the partition plate is a rigid plate; and/or, the buffer column and the second buffer plate are integrally formed; and/or, the buffer column is elastic, one end of the buffer column engaging with the end cover module extends out of the second insertion socket; two ends of the connector include a limiting end and a connecting end, the connecting end is configured to be fixed to the massage head, and the limiting end is configured to abut the end of the buffer column extending out of the second insertion socket.

In some embodiments, the massage device further includes: a vibration generator mounted in the assembly space including the electric motor; a detection component configured to detect a current/voltage of the vibration generator; an indicator light and a main control board, wherein the indicator light and the detection component are electrically connected to the main control board, and the main control board is configured to trigger the indicator light based on the current/voltage detected by the detection component.

In some embodiments, the massage device includes a handheld assembly having a head portion and a rear portion, the massage head is located on the head portion; the handheld assembly includes an outer shell in which the main control board is arranged; a mounting hole is defined in a sidewall of the outer shell adjacent to the main control board, and the indicator light is embedded in the mounting hole.

In some embodiments, the massage device includes a control button arranged on the rear portion and is exposed on an end surface of the rear potion; the main control board is adjacent to the rear portion and is parallel with the end surface of the rear portion; a trigger unit engaging with the control button is arranged on a board surface of the main control board facing the control button.

In some embodiments, the outer shell includes a middle shell and a rear shell, and the rear shell is detachably connected to an end of the middle shell away from the massage head; the main control board is located in the rear shell, the mounting hole is defined in a peripheral sidewall of the rear shell, and the control button is located in the rear shell, extending out of the end surface of the rear shell that faces away from the middle shell.

In some embodiments, a charging hole is defined in the end surface of the rear portion, and a charging connector is arranged on the main control board at a position corresponding to the charging hole; the charging connector extends to the charging hole and is exposed through the charging hole.

In some embodiments, the main control board includes a trigger circuit, which includes a first trigger threshold and a second trigger threshold greater than the first trigger threshold; the trigger circuit is configured to trigger the indicator light to emit a first color when the current/voltage in the vibration generator is equal to or greater than the first trigger threshold, and to trigger the indicator light to emit a second color when the current/voltage in the vibration generator is equal to or greater than the second trigger threshold.

In some embodiments, the vibration generator includes an eccentric member; the electric motor includes a stator, a rotor, and an output shaft; wherein the stator is fixed to the mounting bracket, the rotor is rotatable relative to the stator, and the output shaft is fixed to the rotor; the eccentric member is fixed to the output shaft to rotate eccentrically with the output shaft, and is configured to covert a rotation output by the electric motor into a vibration of the massage head

In some embodiments, the massage device includes a damping balance block and a handheld assembly, the handheld assembly includes an outer shell in which the damping balance block is arranged, the damping balance block is configured to reduce the vibration of the handheld assembly.

In some embodiments, a power supply is arranged in the outer shell and is electrically connected to the main control board and the vibration generator; the power supply is mounted in the outer shell, and the main control board is located at one end of the power supply away from the massage head; the damping balance block is arranged between the power supply and the main control board.

In some embodiments, the damping balance block is connected to one end of the power supply adjacent to the main control board; and/or, an isolation gap being greater than 8 mm is formed between the damping balance block and the main control board.

In some embodiments, the outer shell includes a middle shell and a rear shell, and the rear shell is detachably connected to the end of the massage head away from the middle shell; and the main control board is mounted the rear shell; and the rear shell is connected to the middle shell through a buckle structure, and an avoidance gap is formed on the damping balance block and/or main control board to avoid the buckle structure.

In the technical solution of this application, the mounting bracket, the eccentric member, the electric motor, and the balancing member are installed in the assembly chamber of the massage head; the balancing member is fixed on the rotor or the output shaft of the motor; the eccentric member and the electric motor are respectively mounted on both sides of the mounting bracket; the stator of the electric motor is fixed to the mounting bracket, one end of the output shaft is fixed to the rotor, and the other end thereof is connected to the eccentric member through the mounting bracket. During the operation of the electric motor, the rotor and the balancing member rotate on one side of the mounting bracket, and the eccentric member rotates on the other side of the mounting bracket under the drive of the output shaft. During the rotation process, the eccentric member generates the first eccentric force, which is transmitted to the mounting bracket through the output shaft; the balancing member generates a second eccentric force which is also transmitted to the mounting bracket through the output shaft. With the balancing member, the second eccentric force is balanced with the first eccentric force, which allows the eccentric forces applied to two ends of are substantially equivalent to avoid the defection of the output shaft. After the energy output by the electric motor is converted into the first and second eccentric forces, the first and second eccentric forces are radially transmitted to the massage head through the mounting bracket, causing the massage head to vibrate; during this process, due to the balance of forces, the eccentric member, the rotor, and the balancing member can respectively perform an approximately-standard circular rotation along a moving track close to a standard cylindrical surface, thus, the energy is not consumed due to the deflection, greatly improving the energy efficiency of the massage device. In this way, the vibration of the massage head is greatly improved with the motor power remaining unchanged, which is beneficial for improving the user experience.

### BRIEF DESCRIPTION OF THE DRAWINGS

In order to explain the technical solutions in the embodiments of the present disclosure or the prior art more clearly, the drawings used by the description of the embodiments or the prior art will be briefly introduced below. Obviously, the drawings in the following description may be merely some embodiments of the present disclosure. For those of ordinary skilled in the art, other drawings may be obtained according to the structures shown in the drawings without creative effort.

FIG. 1 is a schematic view of a massage device in accordance with an embodiment of the present disclosure.

FIG. 2 is an exploded view of the massage device in FIG. 1.

FIG. 3 is an exploded view of a massage head of the massage device in FIG. 1 in accordance with an embodiment.

FIG. 4 is an exploded view of a massage head of the massage device in FIG. 1 in accordance with another embodiment.

FIG. 5 is a schematic view showing an internal structure of the massage head of the massage device in FIG. 1 in accordance with an embodiment.

FIG. 6 is a schematic view showing an internal structure of the massage head of the massage device in FIG. 1 in accordance with another embodiment.

FIG. 7 is an exploded view of the massage device in FIG. 1 in accordance with another embodiment.

FIG. 8 is a schematic view of the massage device in FIG. 1 viewed from another angle.

FIG. 9 is a schematic view showing an internal structure of the massage device in FIG. 1 in accordance with an embodiment.

FIG. 10 is a schematic view showing an internal structure of the massage device in FIG. 1 in accordance with another embodiment.

FIG. 11 is a schematic view showing an internal structure of the massage device in FIG. 10 in accordance with an embodiment.

FIG. 12 is an exploded view of the massage device in FIG. 10 in accordance with an embodiment.

FIG. 13 is a schematic view of the massage device in FIG. 10 viewed from another angle.

FIG. 14 is an exploded view of the massage device in FIG. 1 in accordance with another embodiment.

FIG. 15 is a schematic view of the massage device in FIG. 14 viewed from another angle.

The realization of the purpose, functional features and advantages of the present application will be further described with reference to the accompanying drawings in conjunction with the embodiments.

### DETAILED DESCRIPTION OF THE EMBODIMENTS

In the following, the technical solutions in the embodiments of the present disclosure will be clearly and completely described with reference to the drawings in the embodiments of the present disclosure. Obviously, the described embodiments may be only a part of the embodiments of the present disclosure, but not all of the embodiments. Based on the embodiments of the present disclosure, all other embodiments obtained by those of ordinary skilled in the art without creative effort shall fall within the protection scope of the present disclosure.

It is to be understood that, all of the directional instructions in the exemplary embodiments of the present disclosure (such as top, down, left, right, front, back . . . ) can only be used for explaining relative position relations, moving condition of the elements under a form (referring to figures), and so on, if the form changes, the directional instructions changes accordingly.

In addition, descriptions such as “first” and “second” in the present disclosure may be for descriptive purposes only, and cannot be understood as indicating or implying the relative importance or implicitly indicating the number of indicated technical features. Therefore, the features defined as “first” and “second” may explicitly or implicitly include at least one of the features. In addition, the meaning of “and/or” appearing in the context means including three parallel solutions, taking “A and/or B” as an example, “A and/or B” includes only solution A, or only solution B, or both solutions A and B. In addition, the technical solutions among the various embodiments can be combined with each other, but the combinations must be based on what can be achieved by those of ordinary skill in the art. When a combination of technical solutions is contradictory or cannot be achieved, it should be considered that such a combination of technical solutions does not exist and is not within the protection scope claimed by the present application.

This application mainly provides a massage device configured primarily for human body massage. With a balancing member 660 arranged on an electric motor 600, the massage device can achieve an eccentric balance (with the balancing member configured on the electric motor 600, the rotation of the electric motor 600 is an eccentric rotation, and the eccentric rotations on two sides of the mounting bracket 670 are balanced) between an eccentric member 680 and the electric motor 600 on both sides of the mounting bracket 670 (with the balancing member 660). When the electric motor 600 eccentrically rotates with the output shaft 620 of the electric motor 600, rotation axes of the eccentric member 680, a rotor of the electric motor 600, and the balancing member 660 are approximately perpendicular to the mounting bracket 670. Moving tracks of the eccentric member 680, the electric motor 600, and the balancing member 660 are are approximately cylindrical surfaces, effectively avoiding an approximate conical surface caused by any deflection. Consequently, an eccentric force generated during the rotation of the eccentric member 680 (when the eccentric member 660 rotates eccentrically relative to the output shaft 620, the eccentric member 660 generates the eccentric force along a radial direction of the output shaft 620) is transmitted to a massage head 100 through the mounting bracket 670 (which reduces or even eliminates deflection consumption of the eccentric member 680 and the electric motor 600 relative to the mounting bracket 670), improving the vibration efficiency in the massage head 100 and significantly improving the energy efficiency of the massage device (that is, when the rotation speed of the electric motor 600 remains unchanged, the vibration frequency and/or amplitude of the massage head 100 can be significantly improved with the balancing member 660). It is noted that both the electric motor 600 and the eccentric member 680 are located in the massage head 100 in this application, such that the rotation of the electric motor can be efficiently converted into the rotation of the eccentric member 680. Simultaneously, the rotation of the eccentric member 680 directly influences the massage head 100, which greatly reduces the energy transmission path and optimizes the conversion rate from the rotation of the electric motor 600 to the vibration of the massage head 100.

The following will mainly provide an overview of the overall structure of the massage device before delving into the specifics of each component.

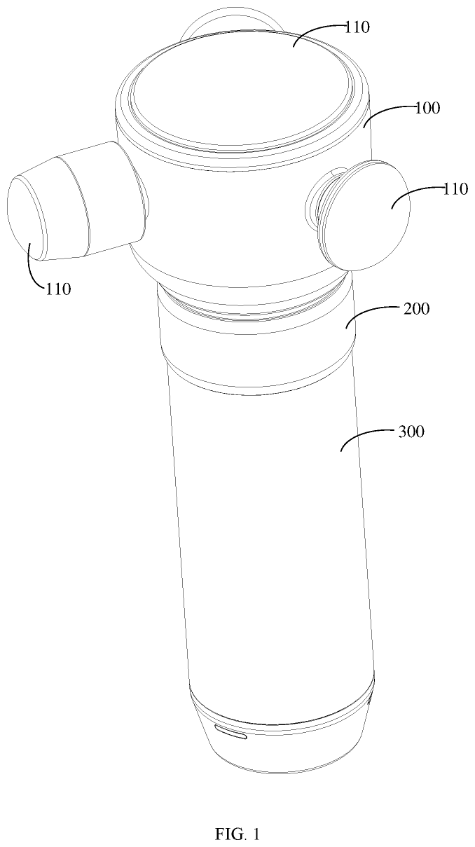

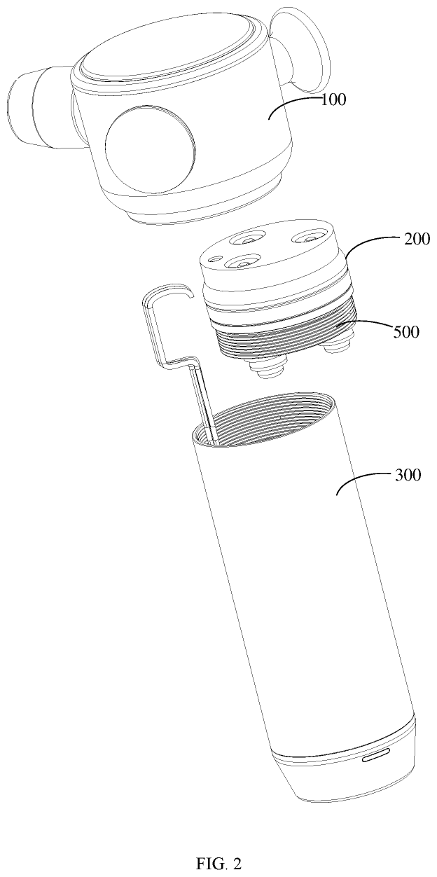

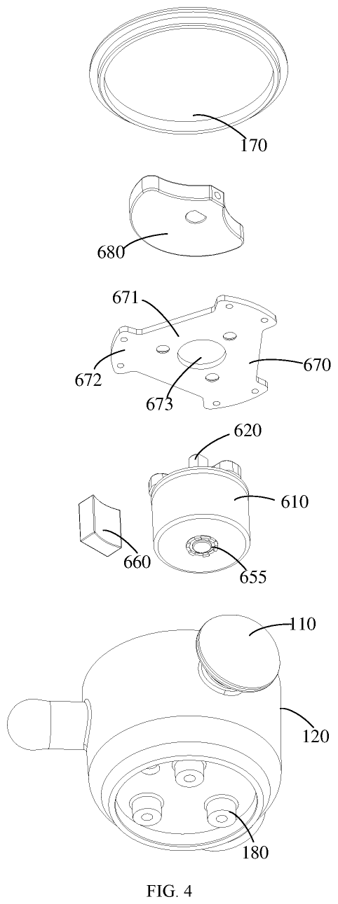

As shown in FIG. 1 to FIG. 6, in the embodiment, the massage device includes a massage head 100, a buffer assembly 200, a handheld assembly 300, and a connecting assembly 500. The massage device can have various vibration shapes, for example, in this embodiment the vibration shape of the massage device can be a lengthy cylinder, and the massage head 100, the buffer assembly 200, and the handheld assembly 300 are arranged in sequence. The massage head 100 is located on one end of the massage device for outputting vibrations. It is understood that in some embodiments, the massage head 100 can further be heated; in other embodiments, the massage head 100 can further be used to provide electric stimulation on muscles and skin (within safe voltage limits), allowing the massaged head 100 to provide various massage forms. The handheld assembly 300 is mainly used to be held by an operation. The handheld assembly 300 can have many shapes, which is not limited herein. In this embodiment, the handheld assembly 300 is shaped as a cylinder as a whole. The buffer assembly 200 is located between the massage head 100 and the handheld assembly 300 to reduce a vibration transmission between the massage head 100 and the handheld assembly 300; thus, when the massage head 100 vibrates at a high frequency, the vibration amplitude of the handheld assembly 300 can be small, which stabilizes the handheld of the massage device by the operation, improves the operation accuracy and thus improves the massage effect. The connecting assembly 500 is configured to connect the massage head 100, the buffer assembly 200, and the handheld assembly 300.

Referring to FIG. 1 to FIG. 6, in some embodiments, in order to improve the energy efficiency of the massage device, and improve the vibration and vibration effect of the massage head 100, the massage device is configured as follows.

The massage device includes a massage head 100, a mounting bracket 670, an electric motor 600, an eccentric member 680, and a balancing member 660. The massage head 100 has at least one massage surface and an assembly space. The mounting bracket 670 is mounted in the assembly space and is fixed to the massage head 100. Both the electric motor 600 and the eccentric member 680 are arranged in the assembly space and are respectively located on opposite sides of the mounting bracket 670. The electric motor 600 includes a stator 615, a rotor, and an output shaft 620. The stator 615 is fixed to the mounting bracket 670, the rotor is rotatable relative to the stator 615, and the output shaft 620 is fixed to the rotor and is rotatably connected to the mounting bracket 670. The eccentric member 680 is fixed to the output shaft 620 to eccentrically rotate with the output shaft 620. The eccentric member is configured to convert the rotation output by the electric motor 600 into the vibration of the massage head 100. The balancing member 660 is located on the same side of the mounting bracket 670 as the electric motor 600 and is connected to the rotor or the output shaft 620, thus, the balancing member 660 can rotate with the rotor or the output shaft 620. The balancing member 660 is configured to balance one end of the output shaft 620 away from the eccentric member 680 (located on both sides of the mounting bracket 670), such that the eccentric member 680, the output shaft 620, the rotor, and the balancing member 660 can respectively rotate along a balanced circle, effectively preventing deflections at both ends of the output shaft 620.

In this embodiment, the massage head 100 can have various shapes as a whole such as a full sphere (or a partial sphere), a cuboid, and etc., which is not limited herein In this embodiment, the massage head 100 is shaped as a cylinder as a whole. The massage head 100 can be made of any suitable material, which is not limited herein; for example, the massage head 100 can be made of rigid material such as stainless steel, cast iron, and tempered glass, which is not limited herein. The massage head 100 has at least one massage surface 110; in other embodiments, the massage head 100 can have two or three or even more massage surfaces.

In some embodiments, the massage surface 110 can be a cylindrical surface or an end surface of the massage head 100. In some embodiments, the massage head 100 could include a shell portion 120 and a massage portion 130 extending from an outer surface of the shell portion 120 which is served as the massage surface 110. The number of the massage portions 130 can be more than one, such as three, which is not limited herein. These massage portions 130 are evenly (an angle formed between adjacent massage portions is) 120° or unevenly arranged along a circumferential direction of the massage head 100. A hardness of each massage portion 130 can be the same or different, for example, the hardness of the massage portions 130 can be sequentially increased. In this embodiment, the massage portions 130 have identical hardness. These massage portions 130 and the shell portion 120 might be separately formed, and the massage portions 130 are arranged on the surface of the shell portion 120; in other embodiments, the massage portions 130 and the shell portion 120 can be integrally formed. It is noted that in some embodiments, a massage sleeve 150 can be sleeved on the massage portion 130 to offer various hardness and shapes for the massage surface 110. The massage sleeve 150 can be detachably connected to the massage portion 130. The hardness and shape of the massage sleeve 150 can be varied according to actual requirements, which is not limited herein. Meanwhile, the number of the massage sleeve 150 matched with the massage head 100 can be more than one. The massage surface 110 is used to interact with the skin on the human body and transmit the vibration from the massage head 100 to the skin and muscles. The massage head 100 is hollow to form the assembly space in which the mounting bracket 670, the eccentric member 680 on one side of the mounting bracket 670, the electric motor 600 and the balancing member 660 on the other side of the mounting bracket 670 are accommodated. In this embodiment, the eccentric member 680, the mounting bracket 670, and the electric motor 600 are arranged consecutively in turn along a lengthwise direction of the massage device, and the electric motor 600 is located adjacent to the handheld assembly 300. The mounting bracket 670 is fixed to the massage head 100, the electric motor 600 is mounted onto the mounting bracket 670, and the eccentric member 680 is fixed to the output shaft 620 of the electric motor 600.

The mounting bracket 670 can be formed in various ways, for example, the mounting bracket 670 can be formed by joining multiple support rods; and the shape of the mounting bracket 670 can be configured according to specific operational requirements, which is not limited herein. The mounting bracket 670 can also be shaped as a plate, which may be integrally formed or assembled by multiple plates. In this embodiment, the mounting bracket 670 is arranged along the radial direction of the massage head 100. After the mounting bracket 670 is mounted in an assembly chamber 121 formed in the shell portion 120, the assembly chamber is divided into two parts. The two parts can be communicated with each other or separated from each other, which is not limited herein. As an example, the two parts includes a first chamber and a second chamber arranged along the axial direction of the massage head 100. One of the eccentric member 680 and the electric motor 600 is mounted in the first chamber, and the other one is mounted in the second chamber.

The eccentric member 680 can have various shapes, such as a strip, a sphere, and a block, which is not limited herein. In some embodiments, the eccentric member 680 is shaped as a block such as a rectangular block, triangular block, circular block, and fan-shaped block. In this embodiment, the eccentric member 680 is a fan-shaped block with a central angle thereof being less than 180° and may range from 30° to 150°, like 60°, 80°, 100°, 110°, 120°, and 130°.

The electric motor 600 includes the stator 615, the rotor, and the output shaft 620 fixed to the rotor. The electric motor 600 can be an outer rotor motor or an inner rotor motor. When the electric motor 600 is an inner rotor motor having an inner rotor, the inner rotor is located in the space surrounded by the stators 615, and the output shaft 620 is fixed to the inner rotor and is capable of rotating with the inner rotor. At this time, the balancing member 660 could be arranged on the inner rotor or the output shaft 620. In some embodiments, the balancing member 660 could be arranged on both the inner rotor and the output shaft 620 simultaneously. When the electric motor 600 is an outer rotor motor having an outer rotor 610, the outer rotor 610 is shaped as a cylinder as a whole and the stator 615 is arranged in the outer rotor. The stator 615 is connected to the mounting bracket 670 through various means, for example, the stator can be directly connected to mounting bracket 670 or can be connected to the mounting bracket 670 through a motor bracket 630 which is connected to the mounting bracket 670. It is noted that, to improve the smoothness of the rotor rotation, the massage device further includes a first bearing 650 arranged between the output shaft 620 and the mounting bracket 670 for connecting the output shaft 620 and the mounting bracket 670. In another embodiment, the first bearing 650 can be arranged between the output shaft 620 and the motor bracket 630 for connecting the output shaft 620 and the motor bracket 630. Moreover, the massage device includes a second bearing 655 arranged between an end of the output shaft 620 away from the eccentric member 680 and the stator 615 for rotatably connecting the output shaft 620 and the stator 615. The end of the output shaft 620 away from the eccentric member 680 is fixed to the rotor.

The balancing member 660 can have various shapes, such as a sheet or a rod. In this embodiment, the balancing member 660 is shaped as a block. The balancing member 660 can be made of many materials like metal or ceramic which can effectively increase the weight. The balancing member 660 can significantly increase the overall weight of the side of the mounting bracket 670 on which the electric motor 600 is located, thus, a centrifugal force generated by the eccentric member 680 during rotation is equal to a centrifugal force generated by the side of the electric motor 600, allowing both sides of the mounting bracket 670 (two ends of the output shaft 620) to achieve a state of eccentric balance.

In the embodiment, the mounting bracket 670, the eccentric member 680, the electric motor 600, and the balancing member 660 are installed in the assembly chamber of the massage head 100; the balancing member 660 is fixed on the rotor or the output shaft 620 of the electric motor 600; the eccentric member 680 and the electric motor 600 are respectively mounted on both sides of the mounting bracket 670; the stator of the electric motor 600 is fixed to the mounting bracket 670, one end of the output shaft 620 is fixed to the rotor, and the other end thereof is connected to the eccentric member 680 through the mounting bracket 670. During the operation of the electric motor 600, the rotor and the balancing member 660 rotate on one side of the mounting bracket 670, and the eccentric member 680 rotates on the other side of the mounting bracket 670 under the drive of the output shaft 620. During the rotation process, the eccentric member 680 generates the first eccentric force, which is transmitted to the mounting bracket 670 through the output shaft 620; the balancing member 660 generates a second eccentric force which is also transmitted to the mounting bracket 670 through the output shaft 620. With the balancing member 660, the second eccentric force is balanced with the first eccentric force, which allows the eccentric forces applied to two ends of are substantially equivalent to avoid the defection of the output shaft 620. After the energy output by the electric motor 600 is converted into the first and second eccentric forces, the first and second eccentric forces are radially transmitted to the massage head 100 through the mounting bracket 670, causing the massage head 100 to vibrate; during this process, due to the balance of forces, the eccentric member 680, the rotor, and the balancing member 660 can respectively perform an approximately-standard circular rotation along a moving track close to a standard cylindrical surface, thus, the energy is not consumed duc to the deflection, greatly improving the energy efficiency of the massage device. In this way, the vibration of the massage head 100 is greatly improved with the motor power remaining unchanged, which is beneficial for improving the user experience.

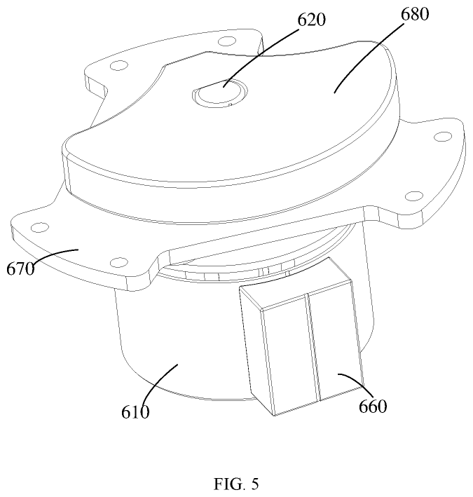

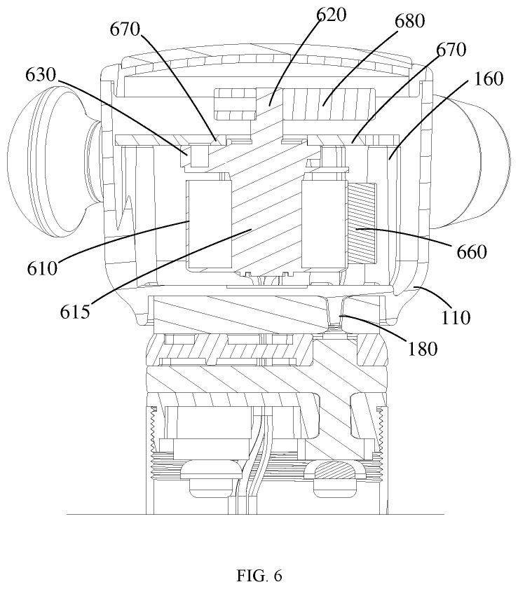

As shown in FIG. 5 to FIG. 6, in some embodiments, to maximize the radial vibration transmitted from the mounting bracket 670 to the massage head 100, the mounting bracket 670 is arranged in the assembly chamber 121 along the radial direction of the output shaft 620, such that the assembly chamber 121 can be divided into a first chamber and a second chamber along the axial direction of the output shaft 620. The eccentric member 680 is located in the first chamber, and the stator 615, the rotor, and the balancing member 660 are located in the second chamber, and the output shaft 620 extends from the second chamber to the first chamber. In this embodiment, the output shaft 620 is arranged in parallel with the massage head 100, and the mounting bracket 670 is arranged along the radial direction of the massage head 100, and the assembly chamber 121 is divided into the first chamber and the second chamber arranged along the axial direction of the massage head 100. With the arrangement, the eccentric forces generated by the eccentric member 680 and the balancing member 660 can be transmitted radially to the massage head 100 via the mounting bracket 670. The radial force applied to the massage head 100 is a radial pressing force, thus, the massage head 100 has a relatively-large radial vibration, which can be directly transmitted to the massage surface 110. In contrast, the axial force applied to the massage head 100 is small, thus, the massage head 100 has a relatively-small axial vibration and the vibrations which can be transmitted to the handheld assembly 300 is correspondingly small. In this way, not only is improved the energy efficiency, but also the vibration of the handheld assembly 300 is significantly reduced, which stabilizes the handheld for the user. Furthermore, the second chamber is arranged adjacent to the handheld assembly 300 and a battery 710 can be arranged in the handheld assembly 300, which can shorten a wiring distance between the electric motor 600 and the battery 710 and allow an electrical connector (which can be a wire, flexible circuit board, etc.) to be directly connected to the electric motor 600 and the battery 710 without the need for extra space, reducing the risk of malfunctions.

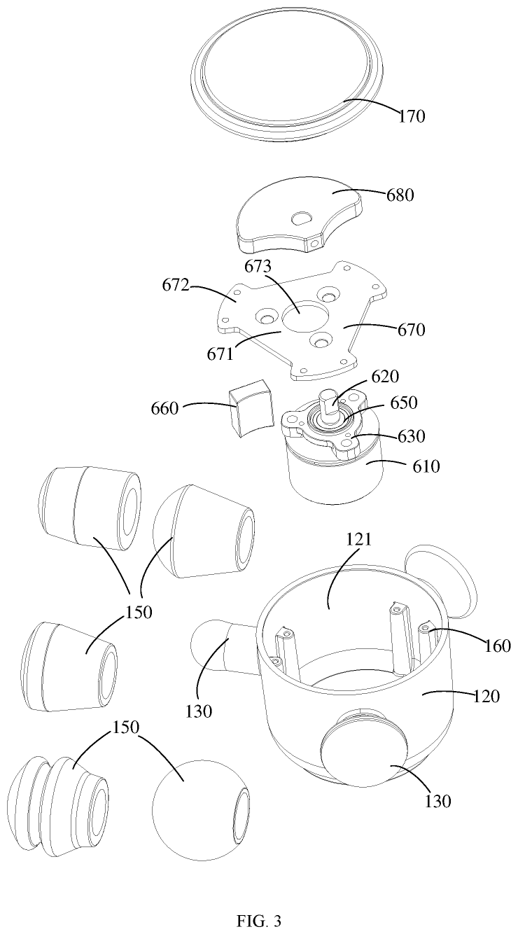

Referring to FIG. 3 to FIG. 6, regarding the specific form of the electric motor 600, the inner rotor motor and the outer rotor motor are respectively introduced below.

When the electric motor 600 is an inner rotor motor, the balancing member 660 is arranged on the inner rotor. And/or, the stator 615 and the rotor extends out of one end of the output shaft 620 away from the eccentric member 680, and the balancing member 660 is arranged on the end of the output shaft 620 away from the eccentric member 680. That is, the balancing member 660 is arranged on the inner rotor, generating an eccentric force as the inner rotor rotates. The eccentric force is then transmitted to the mounting bracket 670. The balancing member 660 can also be arranged on the output shaft 620; correspondingly, the eccentric member 680 is arranged on one end of the output shaft 620 and the balancing member 660 is arranged on the other end of the output shaft 620. At this time, each end of the output shaft 620 is configured with both the stator and the rotor. It is noted that the overall shape of the eccentric member 680 is similar to that of the balancing member 660, and the weight of the eccentric member 680 is substantially equal to that of the balancing member 660, which assures that the eccentric forces applied to the output shaft 620 from the eccentric member 680 and from the balancing member 660 during rotation are substantially equal to each other to balance two ends of the output shaft 620.

When the electric motor 600 is an outer rotor motor, the outer rotor 610 is shaped as a cylinder. The rotor includes a rotary cylinder, which includes an annular sidewall and an end wall located on one end of the sidewall. The balancing member 660 is located on the sidewall and/or the end wall. The stator 615 is located in the rotary cylinder and is fixed to the mounting bracket 670. One end of the rotary cylinder is opened such that the stator 615 can be mounted in the rotary cylinder. The mounting bracket 670 is fixed to the stator 615 at a position corresponding to the opened end of the rotary cylinder. An opposite end of the cylinder has the end wall capable of rotating with the sidewall. The balancing member 660 can be arranged on the annular sidewall of the outer rotor 610 or the end wall. In some embodiments, the balancing member 660 can be arranged on both the annular sidewall and the end wall. When being arranged on the sidewall, the balancing member extends along an axial direction of the cylinder; when being arranged on the end wall, the balancing member extends along a radial direction of the rotation. For improving the connection between the stator 615 and the mounting bracket 670, the electric motor 600 includes a motor bracket 630 located on the end of the rotary cylinder away from the end wall. One side of the motor bracket 630 is fixed to the stator 615 and the other side thereof is fixed to the mounting bracket 670. In this embodiment, the mounting bracket 670 is plate-shaped, and the overall shape of the motor bracket 630 is similar to that of the mounting bracket 670. The motor bracket 630 and the mounting bracket 670 can be fastened together using fasteners like screws and bolts, or buckled together using buckles. The mounting bracket 670 includes a first through hole 673, and the motor bracket 630 includes a second through hole. The first bearing 650 can be mounted in the first through hole 673 or the second through hole, or even in the first through hole 673 and the second through hole simultaneously. The output shaft 620 is rotatably connected to the motor bracket 630 and the mounting bracket 670 through the first bearing 650. Since the mounting bracket 670 is plate-shaped, after the output shaft 620 transmits the eccentric force radially to the mounting bracket 670, the eccentric force is transmitted radially to the massage head 100 by the mounting bracket 670. Since a contact area between the plate-shaped mounting bracket 670 and the massage head 100 is limited, the eccentric force can be transmitted radially. Consequently, the primary vibration direction of the massage head 100 occurs radially, offering a stronger vibration on the massage surface 110 located on the radial outer sidewall of the massage head 100.

In some embodiments, to further improve the vibration efficiency of the massage head 100, a weight ratio of the eccentric member 680 to the balancing member 660 ranges from 1:1 to 10:1. In this embodiment, the weight ratio of the eccentric member 680 to the balancing member 660 needs to be controlled in a reasonable range such that unwanted deflections caused by an force imbalance between the two ends of the output shaft 620 during the rotation can be avoided. In some embodiments, in order to better balance the two ends of the output shaft 620, the weight ratio of the eccentric member 680 to the balancing member 660 ranges 3:1 to 6:1, that is, the weight of the eccentric member 680 can be either 3 times, 3.5 times, 3.7 times, 4 times, 4.5 times, 4.7 times, or 5 times the weight of the balancing member 660. The weight of the eccentric member 680 can be varied, for example, the weight of the eccentric member 680 can range from 11 g to 45 g such as 13 g, 17 g, 20 g, 25 g, 28 g. 30 g. 33 g, 35 g, 40 g, and 42 g. Similarly, the weight of the balancing member 660 also can be varied, for example, the weight of the balancing member 660 can range from 4 g to 11 g such as 5 g, 6 g, 7 g, 8 g, 9 g, and 10 g. In this embodiment, the balancing member 660 is arranged on the sidewall of the outer rotor 610, the eccentric member 680 and the balancing member 660 respectively rotate at an identical speed, the weight of the balancing member 660 is less than that of the eccentric member 680, and a distance between a gravity center of the balancing member 660 and the output shaft 620 is greater than that between a gravity center of the eccentric member 680 and the output shaft 620. Thus, the first eccentric force generated by the rotation of the eccentric member 680 is effectively counterbalanced by the second eccentric force generated by the rotation of the balancing member 660. Meanwhile, since the electric motor 600 and the eccentric member 680 are located on opposite sides of the mounting bracket 670, the weights on two ends of the mounting bracket 670 are effectively balanced by setting the weight of the eccentric member 680 to be greater than that of the balancing member 660, which allows for a balanced rotational state on both sides of the mounting bracket 670 and thereby improves the overall stability of the vibration generation process (during the rotation of the output shaft 620, the stability of the electric motor 600, the eccentric member 680, and the balancing member 660).

In some embodiments, to further improve the balance between the ends during the rotation of the output shaft 620, a ratio of a distance between an outer edge of the eccentric member 680 and the output shaft 620 to a distance between an outer edge of the balancing member 660 and the output shaft 620 ranges from 0.8 to 1.2. And/or, the distance between the outer edge of the eccentric member 680 and the output shaft 620 ranges from 16 mm to 26 mm, and the distance between the outer edge of the balancing member 660 and the output shaft 620 ranges from 16 mm to 26 mm. In this embodiment, the balancing member 660 is located on the outer rotor 610 of the electric motor 600. The eccentric member 680 is shaped as a fan, and the distance between the outer edge of the eccentric member is equal to a radius of the fan. Meanwhile, the distance between the outer edge of the balancing member 660 and the output shaft 620 is equal to the distance between the side of the balancing member 660 facing away from the outer rotor 610 and the output shaft 620, which can be derived by summing up a thickness of the balancing member 660 and the radius of the electric motor 600. A diameter of the electric motor 600 can be varied, such as 30 mm and 38 mm, corresponding to the radius of 15 mm and 19 mm, respectively. To achieve optimal results, it is important to control the ratio of the distance between the outer edge of the eccentric member 680 and the output shaft 620 to the distance between the outer edge of the balancing member 660 and the output shaft 620 in a reasonable range. If the ratio is too large, the eccentric member 680 may exceed radially the balancing member 660 too much, which results in inefficient space utilization and causes difficulty to arrange the components since a balancing member 660 with a large weight is required. Conversely, if the ratio is too small, the balancing member 660 may radially exceed the eccentric member 680 too much, which results in inefficient space utilization and causes difficulty to arrange the components since the eccentric member 680 with a large weight is required. In some embodiments, in order to improve the structural compactness, the distance between the outer edge of the eccentric member 680 and the output shaft 620 is approximately equal to the distance between the outer edge of the balancing member 660 and the output shaft 620. At this time, the radius of the eccentric member 680 is greater than that of the electric motor 600, the outer edge of the eccentric member 680 protrudes from the outer edge of the electric motor 600 to be substantially coplanar with the outer edge of the balancing member 660. The radius of the eccentric member 680 is greater than a sum of the radius of the outer rotor 610 and the thickness of the balancing member 660. For example, the radius of the eccentric member 680 can be 17 mm, 19 mm, 21 mm, 22 mm, or 24 mm, etc.; when the radius of the electric motor 600 is 15 mm, the thickness of the balancing member 660 can be 2 mm, 4 mm, 6 mm, 7 mm, or 9 mm, etc.

In some embodiments, in order to better balance the two ends of the output shaft during rotation, the eccentric member 680 and the balancing member 660 are located on the same side of the output shaft 620. In detail, a periphery of the output shaft 620 is divided into several areas, and the eccentric member 680 and the balancing member 660 are located in the same area. For example, when the periphery is divided into two areas, each area has a 180° center angle; when the periphery is divided into four areas, each area has a 90° center angle. The four areas can be considered corresponding to a front side, a rear side, a left side, and a right side of the output shaft 620. Since the eccentric member 680 and the balancing member 660 are arranged on the same side of the output shaft 620, the eccentric forces generated by the eccentric member 680 and the balancing member 660 substantially have the same direction, leading to a larger combined force output by the output shaft 620. Thus, the forces applied both ends of the output shaft 620 can be ensured to approximately have the same direction to avoid deflections. To further improve the balance effect, the mounting bracket 670 is plate-shaped, and the eccentric member 680 and the balancing member 660 are symmetrical about the mounting bracket 670. Thus, the directions of the forces transmitted to the output shaft 620 by the eccentric member 680 and the balancing member 660 are closer to each other. Under these conditions, when the rotor of the electric motor 600 rotates at a speed ranging 3900 rpm to 12000 rpm, the massage head 100 vibrates at a frequency ranging from 65 Hz to 200 Hz. As the massage head 100 rotates, the massage surface 110 moves along a first moving track approximately circular, which is substantially parallel with the radial direction of the massage head 100. Alternatively, the massage surface 110 may move along a second moving track approximately circular, which is substantially parallel with the axis of the massage head 100. In some embodiments, the moving track of the massage surface 110 is formed by the first and second moving tracks.

In some embodiments, in order to further improve the balance effect during the rotation of the output shaft 620, the eccentric member 680 has a first symmetrical plane parallel with the output shaft 620, while the balancing member 660 has a second symmetrical plane parallel with the output shaft 620, and an included angle formed between the first symmetrical plane and the second symmetrical plane is less than 10°. In this embodiment, the eccentric member 680 has a substantially-symmetrical structure with the first symmetrical plane. That is, the eccentric member 680 is symmetrical about the first symmetrical plane. The balancing member 660 has a substantially-symmetrical structure with the second symmetrical plane. That is, the balancing member 660 is symmetrical about the second symmetrical plane. It is noted that the term “substantially-symmetrical” means that the structures of the eccentric member 680 and the balancing member 660 are roughly symmetrical rather than strictly symmetrical, and the weights on both sides of the symmetrical plane are substantially equal to each other. The included angle between these two symmetrical planes can be 9°, 7°, 6°, 5°, 3°, 2°, 1°, and so on. In some embodiments, the first and second symmetrical planes might even closely coincide. Thus, the first eccentric force applied to the output shaft 620 by the eccentric member 680 may have a direction substantially the same as that of a second eccentric force applied to the output shaft 620 by the balancing member 660, which significantly improves the rotation stability of the output shaft 620.

In some embodiments, in order to improve the vibration of the massage head 100, the massage head 100 includes a shell portion 120 and a massage portion 130 located on an outer sidewall of the shell portion 120. The massage portion 130 has a massage surface, the shell portion 120 has an assembly space, and the mounting bracket 670 is fixed to an inner sidewall of the assembly space at a position corresponding to the massage portion 130.

In this embodiment, the first eccentric force and the second eccentric force applied to the output shaft 620 are transmitted to the shell portion 120 of the massage head 100 through the mounting bracket 670. At this time, a connection position of the shell portion 120 connected to the mounting bracket 670 receives the maximum force and the connection position thus has the strongest vibration. By connecting the massage portion 130 to the connection position, the massage portion 130 can correspondingly has a strong vibration, which improves the overall vibration of the massage surface 110. The mounting bracket 670 and the shell portion 120 can be connected through various connection methods, which is illustrated below in combination with examples. The massage head 100 can include multiple massage portions 130 evenly arranged along a circumferential direction of the shell portion 120. The mounting bracket 670 includes a bracket body 671 and several mounting portions 672 evenly arranged along a circumferential direction of the bracket body 671. These mounting portions 672 are connected to the shell portion 120 at positions at which the massage portions 130 are arranged. In this embodiment, a mounting column 160 is arranged on the inner sidewall of the shell portion 120 at a position corresponding to the massage portion 130. The massage portion 130 and the mounting column 160 are fastened using screws, buckles, or similar fasteners. The mounting column 160 extends along an axial direction of the shell portion 120, with each mounting portion 672 corresponding to one or two mounting columns 160. In this embodiment, each mounting portion 672 corresponds to two parallel mounting columns 160, and the massage portions 130 forms fastening holes such that the mounting portion 672 can be securely fastened through screws. The mounting column 160 can bear a part of the force from the mounting bracket 670, significantly improving the load-bearing capacity of the shell portion 120; furthermore, the mounting column 160 can quickly transmit the force to other areas of the shell portion 120, thus facilitating the overall vibration of the shell portion 120. In some embodiments, the massage head 100 can also include a cover body 170 covered on an opening of the shell portion 120.

Referring to FIGS. 1 to 6, in some embodiments, to improve the stability of the massage device's operation, the massage head 100 includes a shell portion 120 having an assembly space. The shell portion 120 has an opened end and a blocking end corresponding to the opened end. The opened end includes an opening communicating with the assembly space. A wire hole is defined in the blocking end, a wire structure is arranged on an inner sidewall of the assembly space, with one end of the wire structure being adjacent to the wire hole, and the other end thereof extending along a lengthwise direction of the shell portion 120. In this embodiment, the wire structure includes a wire slot extending along an axial direction of the shell portion 120. The wire slot and the wire hole are arranged along the axial direction of the shell portion 120, thus, the wire can enter the wire slot after passing through the wire hole. One end of the wire slot away from the wire hole is adjacent to the mounting bracket 670, thus, the wire can extend to be above the outer rotor 610 after passing through the wire hole and the wire slot to be electrically connected to the stator 615. As a result, during the rotation of the outer rotor 610, the wire remains uncoiled, thereby facilitating a secure, dependable, and stable electrical connection of the electric motor 600, and thus improving the operational stability of the massage device.

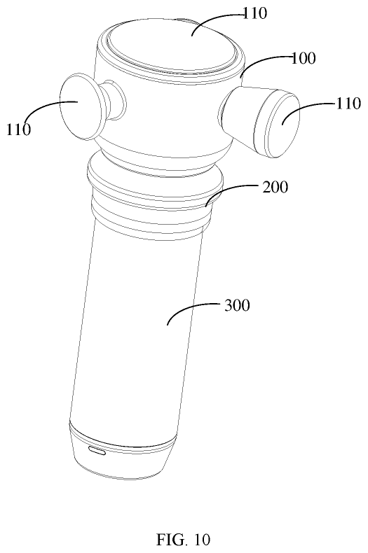

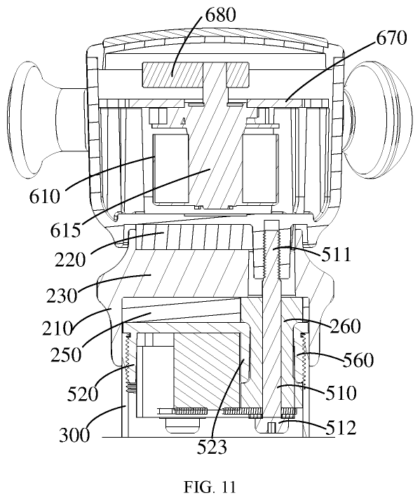

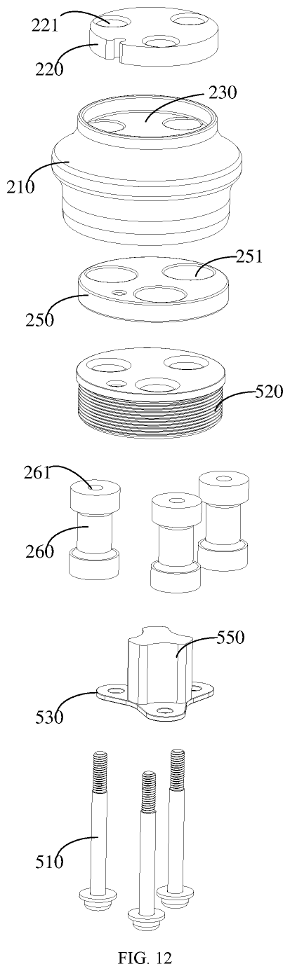

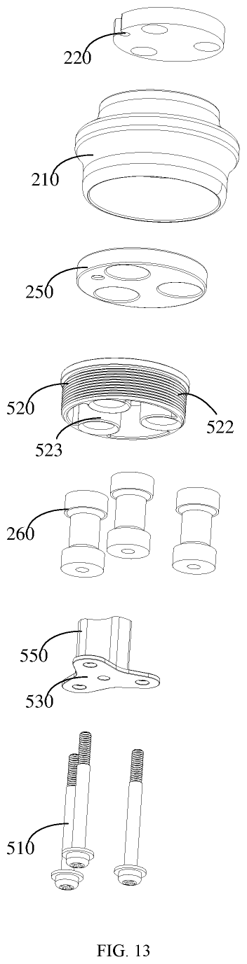

Referring to FIGS. 10 to 13, in some embodiments, in order to improve the user's comfort while holding the message devices and reduce the vibration of the handheld assembly 300, the application further provides a massage device.

The massage device includes a massage head 100, a buffer assembly 200, a handheld assembly 300, a connection component 500, an electric motor 600, and an eccentric member 680. The massage head 100 has at least one massage surface and forms an assembly space in which the electric motor 600 and the eccentric member 680 are arranged. The electric motor 600 includes a stator 615, a rotor, and an output shaft 620. The stator 615 is fixed to the massage head 100, the rotor is rotatable relative to the stator 615, and the output shaft 620 is fixed to the rotor. The eccentric member 680 is fixed to the output shaft 620 to eccentrically rotate with the output shaft 620, and an eccentric block of the eccentric member 680 is used to convert the rotation of the electric motor 600 into the vibration of the massage head 100. The handheld assembly 300 can be held by an user. The buffer assembly 200 is clastic and/or flexible, one end of the buffer assembly 200 abuts an end of the massage head 100, and the other end thereof is connected to the handheld assembly 300. The buffer assembly 200 is configured to effectively reduce the vibration transmission between the massage head 100 and the handheld assembly 300. The connecting assembly 500 is configured to connect the handheld assembly 300 and the massage head 100 to fix the buffer assembly 200 between the massage head 100 and the handheld assembly 300. The connecting assembly 500 includes at least one strip-shaped connector 510. One end of the connector 510 is directly or indirectly connected to the handheld assembly 300, and the other end thereof passes through the buffer assembly 200 to be fixed to the massage head 100.

The handheld assembly 300 as a whole is shaped as a cylinder, and at least a part of the cylinder is hollow or provided with components, which is not limited herein. The buffer assembly 200 can be fixed to the end of the massage head 100 directly or through other components (eg., the connecting assembly 500). That the buffer assembly 200 is elastic and/or flexible means that at least a part of the buffer assembly 200 is elastic and/or flexible. In some embodiments, all the components of the buffer assembly 200 can be made of flexible and/or clastic materials; in other embodiments, at least some components of the buffer assembly 200 can be made of rigid materials.

The buffer assembly 200 is fixed between the massage head 100 and the handheld assembly 300; in some embodiments, the whole buffer assembly 200 is located between the massage head 100 and the handheld assembly 300; in other embodiments, only a part of the buffer assembly 200 is located between the massage head 100 and the handheld assembly 300. The buffer assembly 200 can be located between the massage head 100 and the handheld assembly 300 in an axial direction of the massage device, in such a configuration, the massage head 100, the buffer assembly 200, and the handheld assembly 300 are sequentially arranged along the lengthwise direction of the massage device, facilitating the vibration transmission from the massage head 100 to the handheld assembly 300 along the axial direction of the massage device. In some embodiments, the buffer assembly 200 can be located radially between the massage head 100 and the handheld assembly 300; in such a configuration, the massage head 100 and the handheld assembly 300 are arranged along the lengthwise direction of the massage device, with the buffer assembly 200 radially located between the massage head 100 and the handheld assembly 300, thus, the vibration from the massage head 100 is radially transmitted to the handheld assembly 300.

The connector 510 can be made of rigid plastic or rigid ceramic, etc. In this embodiment, the connector 510 is made of rigid metal. The connector 510 can be connected to the massage device 100 in various ways, such as threaded connections, buckle connections, and the like. The connector 510 can be directly connected to the handheld assembly 300 or connected to the handheld assembly 300 through an intermediary component. The connector 510 can be connected to the handheld assembly 300 in various ways, such as locking connections, screw connections, and the like. Both ends of the connector 510 are respectively connected to the massage device 100 and the handheld assembly 300 to clamp the buffer assembly 200 therebetween, such that the vibrations from the massage head 100 are reduced by the buffer assembly 200 before being transmitted to the handheld assembly 300.

In this embodiment, the message device includes the massage head 100, the buffer assembly 200, the connecting assembly 500, and the handheld assembly 300, and the buffer assembly 200 is clamped between the massage head 100 and the handheld assembly 300 through the connecting assembly 500, thus, the vibrations generated by the massage head 100 can be effectively reduced before being transmitted to the handheld assembly 300, which greatly reduces the vibration of the handheld assembly 300. The connecting assembly 500 includes the strip-shaped connector 510, and the massage head 100 and the handheld assembly 300 are connected to two ends of the connector 510, thus, the connection between the massage head 100 and the handheld assembly 300 can be secured and the buffer assembly 200 can be stably clamped between the massage head 100 and the handheld assembly 300. In this way, a part of the vibrations generated by the massage head 100 is absorbed and consumed by the buffer assembly 200 when being transmitted to the handheld assembly 300 along the axial direction of the buffer assembly 200; furthermore, since the connector 510 passes through the buffer assembly 200, the other part of the vibrations generated by the massage head 100 is transmitted to the buffer assembly 200 along the radial direction of the connector 510 when being transmitted to the handheld assembly 300; thus, the buffer assembly 200 receives the vibrations transmitted axially and radially, which interact with each other to accelerate the consumption of the vibration energy, and significantly reduces the vibration transmitted from the massage head 100 to the handheld assembly 300, and thus improves the comfort and operational stability for the user holding the handheld assembly 300.

In some embodiments, to facilitate the connection, the connecting assembly 500 includes an end cover module 560. The handheld assembly 300 includes a handheld tube 310, and the end cover module 560 is fixed to an end of the handheld tube 310. One end of the connector 510 is connected to the massage head 100, and the other end thereof is configured to engage with the end cover module 560.

In this embodiment, the handheld tube 310 is hollow, and the end cover module 560 can be connected to the handheld tube 310 in various ways, such as in buckle connection or threaded connection. Taking the threaded connection as an example, different threaded connection ways can be used. For example, the end cover module 560 has internal threads, and the end of the handheld tube 310 has external threads, and an end cover 520 is sleeved on the handheld tube 310. Alternatively, the end cover module 560 can have external threads, and the end of the handheld tube 310 can have internal threads, and the end cover 520 can be partly accommodated within the handheld tube 310. Thus, in the assembly process, one end of the connecting assembly 510 can pass through the end cover module 560 at first to be fixed to the massage head 100, and the end cover module 560 is connected to the handheld tube 310, thereby connecting the massage head 100, the connector 510, and the handheld assembly 300 conveniently.

The end cover module 560 defines a through hole, and the connector 510 includes a limiting end 512 and a connecting end 511. The connecting end 511 is configured to be fixed to the massage head 100 through the through hole. A radial size of the limiting end 512 is greater than that of the through hole, and the limiting end 512 is configured to abut one side of the end cover module 560 that faces away from the massage head 100 when the connecting end 511 is fixed to the massage head 100. In this embodiment, one end of the connector 510 fixed to the massage head 100 is formed with external threads (or internal threads), an end surface of the massage head 100 that faces the handheld assembly 300 defines a threaded hole (or external threads), and the connector 510 and the massage head 100 are threaded together. The threaded hole can be directly defined in the end surface of the massage head 100. In some embodiments, a connecting column 180 can be arranged on the end surface and the threaded hole is defined in the connecting column 180. In this way, a length of the threaded connection of the connector 510 can be significantly extended without increasing a thickness of the end of the massage head 100, which stabilize the connection. Since the radial size of the limiting end 512 is greater than that of the through hole, when the connector 510 and the massage head 100 are connected to a certain position, the limiting end 512 may abut (directly or indirectly) the side of the end cover module 560 that is facing away from the massage head 100 until the connector 510 fixes the end cover module 560, the buffer assembly 200, and the massage head 100 together.

As shown in FIGS. 10 to 13, in some embodiments, to further reduce the vibration transmitted to the handheld assembly 300, the end cover module 560 includes both an end cover 520 and a buffer column 260. The end cover 520 is connected to the handheld tube 310, and the buffer column 260 is mounted on the end cover 520. One end of the buffer column 260 abuts the buffer assembly 200 for reducing the vibration transmission between the buffer assembly 200 and the end cover 520. In this embodiment, an end of the buffer column 260 abuts the buffer assembly 200 such that a part of the vibration of the buffer assembly 200 can reach the buffer column 260. The buffer column 260 is clastic or flexible and can be made of rubber-like materials such as rubber or silicone. When the vibration from the buffer assembly 200 is transmitted to the buffer column 260, the buffer column 260 can absorb or consume some of the vibration energy, thus, the vibration transmitted to the end cover 520 is reduced and the vibration experienced by the handheld assembly 300 is thus reduced. It noted that the buffer column 260 can abut the end surface of the buffer assembly 200; or, the buffer assembly 200 may define a through hole and the buffer column 260 extends into this through hole to abut an inner sidewall of the through hole.

In some embodiments, in order to improve the damping effect of the buffer column 260, the buffer column 260 includes a first through hole 261. The buffer column 260 is sleeved on the connector 510 and is tightly engaged with the connector 510 to reduce the vibration transmission between the connector 510 and the end cover 520. In this embodiment, by defining the first through hole 261 and sleeving the buffer column 260 on the connector 510, the vibration of the connector 510 can be transmitted to the buffer column 260 and thus the vibrations transmitted from the connector 510 to the end cover 520 is reduced. It is noted that since the buffer column 260 abuts the buffer assembly 200, the vibration can be transmitted along the axis of the buffer column 260; the buffer column 260 is sleeved on the connector 510, thus, the buffer column 260 can simultaneously receive the vibrations from the axial direction and the radial direction, which allows the buffer column 260 to consume the vibration energy rapidly and thus can significantly reduce the vibration.

In some embodiments, in order to better reduce the vibration, multiple connectors 510 are arranged each which is sleeved by the buffer column 260. The end cover module 560 also includes a fastener plate 530, which tightly abuts the end of the buffer column 260 away from the buffer assembly 200. A second through hole is defined in the fastener plate 530 at a position corresponding to the buffer column 260. The connector 510 is connected to the massage head 100 by passing through the second through hole and the first through hole 261. The fastener plate 530 is configured for restricting the ends of the multiple buffer columns 260 and the ends of the connectors 510 away from the massage head 100.

In this embodiment, the number of connectors 510 can be more than one, such as 2, 3, and 5, which is not limited herein. Taking the number of the buffer column 250 being 3 as an example, the three connectors 510 are arranged in a triangular configuration. Correspondingly, the number of the buffer columns 260 is the same as that of the connectors 510. A buffer column 260 is sleeved on each connector 510 and covers the end cover 520. The fastener plate 530 is arranged on the end of each connector 510 which is away from the massage head 100, that is, the limiting end 512. The fastener plate 530 connects the limiting ends 512 of the multiple connectors 510 together, thereby fixing the limiting ends 512 together and improving the relative stability among the connectors 510. At this time, one side of the fastener plate 530 is attached to the end surface of the buffer column 260, and the other side thereof abuts the limiting end 512. In this way, when the connectors 510 are fastened to the massage head 100, the fastener plate 530 can restrict the limiting ends 512 of the multiple connectors 510 radially as well restrict the multiple buffer columns 260 axially.

In some embodiments, to improve the structural compactness and further minimize the vibration, the end cover module 560 includes a limiting block 550 arranged in an area formed by the multiple buffer columns 260. The limiting block 550 forms a limiting space matched with the shapes of the buffer columns 260 such that the limiting block 550 can be attached to outer sidewalls of the buffer columns 260. The limiting block 550 is located between the end cover 520 and the fastener plate 530, with one end thereof abutting the fastener plate 530 and the other end thereof abutting the end cover 520. In this embodiment, the limiting block 550 is made of elastic material, and the shape of the limiting block 550 is matched with the buffer columns 260, allowing the limiting block 550 to be attached to the outer sidewalls of the buffer columns 260. When the vibration is transmitted to the buffer column 260, the buffer column 260 further transmits the vibration to the limiting block 550 and thus the limiting block 550 is elastically deformed, which relieves and reduces the vibration and thus reduces the vibration transmitted to the end cover 520. By arranging the limiting block 550 between the end cover 520 and the fastener plate 530, vibrations on both the fastener plate 530 and the end cover 520 are transmitted to the limiting block 550; the limiting block 550 correspondingly is elastically deformed to relieve and reduce the vibration. It is noted that when the limiting block 550 fulfills the conditions stated in the two previous embodiments, the buffer column 260 transmits the vibration radially to the limiting block 550, while the end cover 520 and the fastener plate 530 transmit the vibration axially to the limiting block 550, which causes the limiting block 550 to bear the vibrations radially and axially, allows the vibration energy to be consumed rapidly, and thus significantly improves the vibration reduction effect.

The buffer column 260 can be connected to the end cover 520 in various ways, for example, the end cover 520 includes a cover body 523 and a limiting cylinder 522. The limiting cylinder 522 is fixed to the cover body 523 and has a third through hole running through a lengthwise direction of the limiting cylinder 522. At least a part of the buffer column 260 is located within the third through hole. The buffer column 260 includes two fitting segments located at both ends and an assembly segment located between the two fitting segments. A radial size of the assembly segment is less than that of the fitting segment. The limiting cylinder 522 is located in the cover body 523, and the assembly segment is received in limiting cylinder 522, and the fitting segment extends outwards from the cover body 523. In this embodiment, the cover body 523 is shaped as a cylinder as a whole, and the limiting cylinder 522 extends along an axial direction of the cover body 523. This limiting cylinder 522 includes the third through hole in which the assembly segment of the buffer column 260 is mounted. One of the two fitting segments passes through the third through hole with elastic deformation and subsequently restores to its original size. One of the fitting segments abuts the buffer assembly, while the other one abuts the limiting end 512 of the connector 510. By arranging the buffer column 260 and the limiting cylinder 522 in this manner, the buffer column 260 can be conveniently and reliably mounted onto the end cover 520.

The handheld tube 310 is hollow in which a power supply is arranged. The power supply is electrically connected to the electric motor 600 through a conductor. One end of the handheld tube 310 is opened and at least a part of the buffer column 260 is received in the handheld tube 310. One end of the handheld tube 310 engaging with the end cover 520 is opened and the end cover 520 covers the opening of the handheld tube 310, thus, a part of the end cover 520, a part of the buffer column 260 and a part of the connecting assembly 510 can be received in the handheld tube 310. In this way, the space within the handheld tube 310 can be fully utilized to allow for a compact structure among the handheld assembly 300, the buffer assembly 200, and the massage head 100, which improves the connection reliability between these components. The conductor can have various forms such as a wire or a flexible circuit board, which is not limited herein. By arranging the power supply within the handheld tube 310 and electrically connecting the power supply to the electric motor 600 through a conductor, the massage device can work without needing an external power supply, which greatly improves the convenience of using the massage device and optimizes the utilization of space within the handheld tube 310.

The buffer assembly 200 can have various forms. In this embodiment, the buffer assembly 200 includes a buffer plate assembly. One end of the buffer plate assembly abuts the massage head 100 and the other end thereof abuts the connecting assembly 500. The connecting assembly 500 includes the end cover module 560 fixed to an end of the handheld assembly 300. One end of the connector 510 is connected to the massage head 100, while the other end thereof engages with the end cover module 560. The buffer plate assembly is clamped between the end cover module 560 and the massage head 100 to reduce the vibration transmitted therebetween.

The buffer plate assembly can have various forms, for example, the buffer plate assembly can be integrally formed, can be a combination of multiple components or can be formed with multiple separate components, which is not limited herein. Taking the buffer plate assembly being formed with multiple separate components as an example, one side of the buffer plate assembly facing the massage head 100 forms a first insertion socket 221. A connecting column 180 is arranged on the end surface of the massage head 100 facing the buffer plate assembly and the connecting column 180 is inserted into the first insertion socket 221. The insertion engagement can position and limit the buffer plate assembly such that the connection between the massage head 100 and the buffer plate assembly can be more accurate and reliable.

In some embodiments, one side of the buffer plate assembly facing the end cover module 560 includes a second insertion socket 251. The end cover module 560 includes an end cover 520 and a buffer column 260 is mounted on the end cover 520. One end of the buffer column 260 is exposed on the end cover 520 and is inserted into the second insertion socket 251. The insertion engagement can position and limit the buffer plate assembly such that the connection between the buffer column 260 (the end cover module 560) and the buffer plate assembly can be more accurate and reliable.

In some embodiments, in order to improve space utilization and overall structural compactness, one side of the buffer plate assembly facing the massage head 100 forms a first insertion socket 221, a connecting column 180 is arranged on the end surface of the massage head 100 facing the buffer plate assembly and is inserted into the first insertion socket 221. One end of the connecting assembly 510 is fixed to the connecting column 180. The difference between this embodiment and the previous embodiment lies in that, the connecting column 180 in this embodiment is not only inserted to the buffer plate assembly and but also is fixed to one end of the connecting assembly 510. Thus, the connecting column 180 can engage with both the buffer plate assembly and the connecting assembly 510, which eliminates the need for extra hole structures provided for connecting the massage head 100 and the connector 510, simplifies the structure and process of the buffer plate assembly, and improves the overall structure compactness of the massage device.

In some embodiments, in order to improve the structural compactness, one side of the buffer plate assembly facing the massage head 100 forms a first insertion socket 221. A connecting column 180 is arranged on the end surface of the massage head 100 facing the buffer plate assembly and the connecting column 180 is inserted into the first insertion socket 221. Similarly, one side of the buffer plate assembly facing the end cover module 560 forms a second insertion socket 251, a connecting column 180 is arranged on the end surface of the massage head 100 facing the buffer plate assembly and is inserted into the first insertion socket 221. The first insertion socket 221 and the second insertion socket 251 are coaxial and communicated with each other, thus, the connector 510 can pass through the buffer column 260 and the buffer plate assembly to be fixed to the connecting column 180, which not only ensures a compact structure, but also provides more vibration reduction paths during the transmission of the vibration from the massage head 100 to the handheld assembly 300, reducing the vibration transmitted to the handheld assembly 300.

The buffer assembly 200 includes a buffer sleeve 210. The buffer plate assembly includes a partition plate 230 and a first buffer plate 220. The partition plate 230 is firmly arranged in the buffer sleeve 210, and the first buffer plate 220 is arranged on the side of the partition plate 230 facing the massage head 100. A connecting column 180 is arranged on one end of the massage head 100 that faces the first buffer plate 220 and the connecting column 180 is inserted into the first insertion socket 221. Moreover, one side of the massage head 100 facing the first buffer plate 220 is formed with an assembly groove receiving at least a part of the first buffer plate 220. In some embodiments, the buffer plate assembly includes a partition plate 230 and a second buffer plate 250. The partition plate 230 is fixed in the buffer sleeve 210, and the second buffer plate 250 is located on the side of the partition plate 230 that faces the end cover module 560. The end cover module 560 includes an end cover 520 and a buffer column 260 mounted on the end cover 520. One end of the buffer column 260 is exposed on the end cover 520 and is inserted into the second insertion socket 251. In some embodiments, the buffer plate assembly includes the first buffer plate 220 and the partition plate 230 stacked on the first buffer plate 220, and the first buffer plate 220 is located between the partition plate 230 and the end of the massage head 100. Similarly, in some embodiments, the buffer plate assembly includes a second buffer plate 250, a partition plate 230 and an end cover module 560 sequentially stacked. The partition plate 230 can be arranged in the buffer sleeve 210 in various ways, for example, the partition plate 230 can be mounted in the buffer sleeve 210 or the partition plate 230 can be integrally formed with the buffer sleeve 210. The first buffer plate 220 and the third buffer plate can be flexible rubber plates, and the partition plate 230 can be a flexible rubber plate or a rigid plate.

In some embodiments, to maintain the cleanliness and improve the operational stability of the massage device, the buffer assembly 200 further includes a buffer sleeve 210. At least a part of the end cover module 560 is received in the buffer sleeve 210. The buffer sleeve 210 includes a first end and a second end, the first end is sleeved on the end of the massage head 100 adjacent to the buffer assembly 200; and/or, the second end is sleeved on the end of the handheld assembly 300 adjacent to the buffer assembly 200. In this embodiment, the buffer sleeve 210 can be substantially cylindrical with a protruding flange radially protruding from a middle portion thereof. The first end is sleeved on the end of the massage head 100 to enclose the connection position between the massage head 100 and the buffer plate assembly, which can reduce or even avoid external factors like water or mosquitoes from entering and impacting the massage device. Similarly, the second end of the buffer sleeve 210 is sleeved on the end of the handheld assembly 300 adjacent to the buffer assembly 200 to enclose the connection position between the handheld assembly 300 and the buffer plate assembly, which can reduce or even avoid external factors like water or mosquitoes from entering and impacting the massage device.

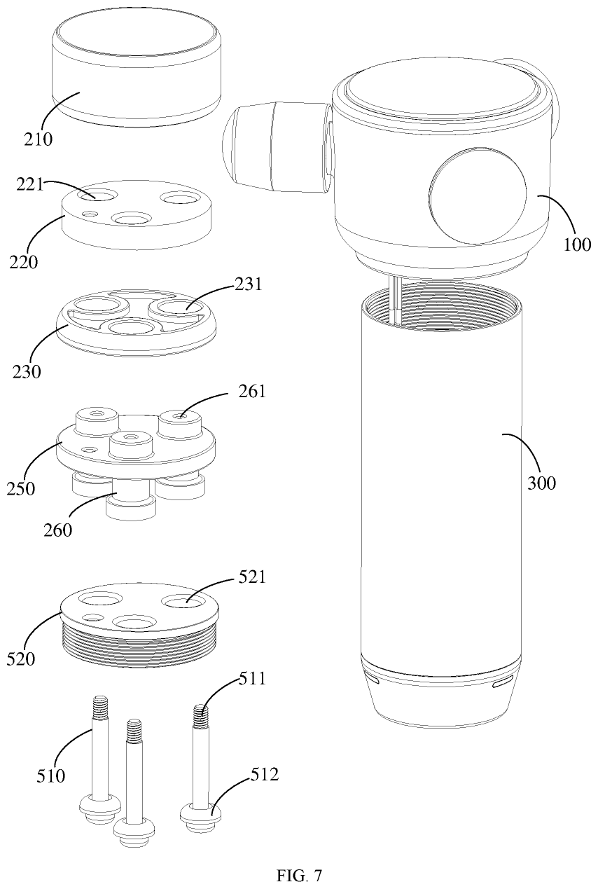

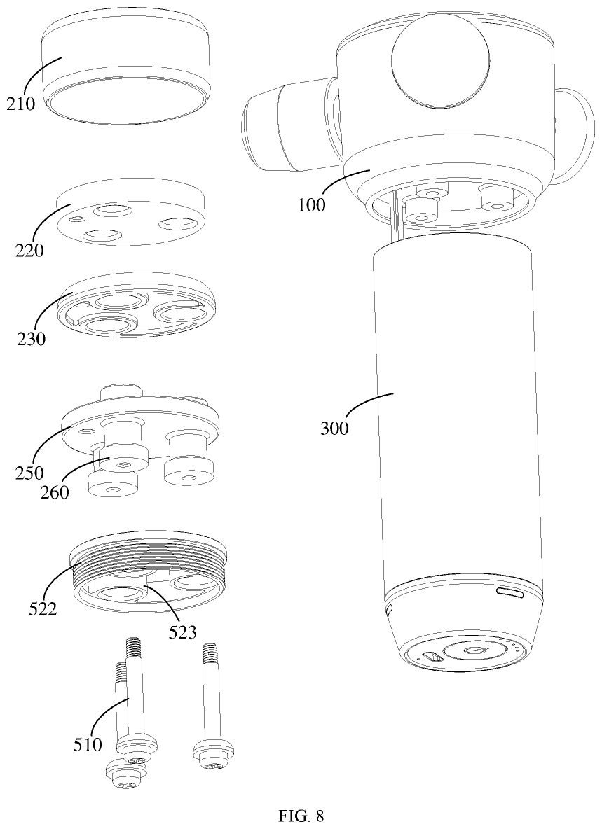

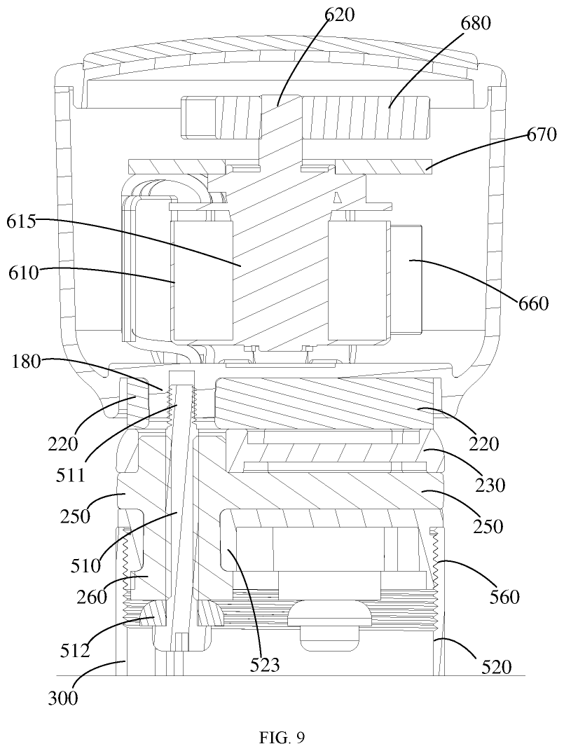

As shown in FIG. 7 to FIG. 9, in different embodiments, the specific structure of the buffer plate assembly may be different, which is illustrated below in combination with some examples. The buffer plate assembly includes a partition plate 230 and a second buffer plate 250 located between the partition plate 230 and the end cover module 560. A buffer column 260 is arranged on the second buffer plate 250 extending along a thickness direction thereof. One side of the partition plate 230 that faces the second buffer plate 250 forms a first insertion socket 231 and one end of the buffer column 260 is inserted into the first insertion socket 231. And/or, one side of the end cover module 560 that faces the second buffer plate 250 forms a second insertion socket 521 and one end of the buffer column 260 away from the partition plate 230 is inserted into the second insertion socket 521.

In this embodiment, the buffer column 260 can be arranged on the second buffer plate 250 in various ways, for example, the buffer column 260 can be fixed to the second buffer plate 250; in other embodiments, the buffer column 260 and the second buffer plate can be integrally formed. The buffer column 260 is approximately perpendicular to a surface of the second buffer plate 250. One end of the buffer column 260 is inserted into the first insertion socket 231 of the partition plate 230 (facilitating positioning and connection of the second buffer plate 250 and the partition plate 230), and the other end thereof is inserted into the end cover module 560 via the second insertion socket 521 (facilitating the positioning and connection of the second buffer plate 250 and the end cover module 560). It is noted that the buffer column 260 is elastic to improve the buffering effect of the buffer assembly 200. The end of the buffer column 260 engaging with the end cover module 560 extends out of the second insertion socket 521. The connector 510 has two ends, namely a limiting end 512 and a connecting end 511. The connecting end 511 is fixed to the massage head 100, and the limiting end 512 abuts the end of the buffer column 260 extending out of the second insertion socket 521. Specifically, when the connecting end 511 is fixed to the massage head 100, the limiting end 512 extends out of the buffer column 260 to abut and press the buffer column 250 towards the massage head 100. Since the buffer column 260 is elastic, the buffer column 260 is elastically deformed when being abut and pressed by the limiting end 512, such that the end cover module 560, the second buffer plate 250, and the partition plate 230 can be tightly engaged with each other. Meanwhile, the end cover 520 is made of rigid material (eg., metal, that is, the metal end cover 520) and the connector 510 is as well made of rigid material (eg., metal, that is, the metal connector 510); and the end cover 520 and the connector 510 are separated by the limiting end 512, preventing any direct, rigid contact or compression between the end cover 520 and the connector 510 and thus improving service life of the end cover 520 and the connector 510. Furthermore, when the massage head 100 works, both the end cover 520 and the connector 510 receive different levels of vibrations; the buffer column 260 can avoid collision and friction between the two rigid components and thus reduce the noise generated by the massage head 100.

In some embodiments, in order to improve the structural compactness and vibration reduction capability of the buffer assembly 200, the buffer plate assembly includes a first partition plate 230 and a second buffer plate 250 located between the partition plate 230 and the end cover module 560. A buffer column 260 is arranged on the second buffer plate 250 extending through a thickness direction thereof. One side of the partition plate 230 facing the second buffer plate 250 forms a first insertion socket 231, and one end of the buffer column 260 is inserted into the first insertion socket 231. One side of the end cover module 560 facing the second buffer plate 250 forms a second insertion socket 521, and one of the buffer column 260 away from the partition plate 230 is inserted into the second insertion socket 521. The first insertion socket 231 passes through the partition plate 230, and the second insertion socket 521 passes through the end cover module 560. The buffer column 260 includes a first through hole 261 running through a lengthwise direction thereof, and the connector 510 passes through the first through hole 261, the first insertion socket 231, and the second insertion socket 521 to be fixed to the massage head 100, which reduces the vibration transmission between the connector 510, the end cover 520, and the partition plate 230. In this embodiment, the partition plate 230 is made of rigid material, and the second buffer plate 250 is made of flexible or elastic buffering material. One end of the connector 510 passes through the buffer column 260 to be connected with the massage head 100, at this time, the vibration can be transmitted to the massage head 100 through two paths; in one path, the vibration is transmitted to the handheld assembly 300 from the massage head 100 through the buffer assembly 200, in the other path, the vibration is transmitted to the handheld assembly through the connector 510. When the vibration is transmitted through the buffer plate assembly, the buffer plate assembly transmits the vibration axially to the handheld assembly 300, effectively reducing the vibration during transmission. Since the buffer column 260 is arranged on the second buffer plate 250 (which is also connected to the partition 230), as the second buffer plate 250 transmits the vibration axially, the buffer column 260 concurrently transmits the vibration axially. On the other hand, when the vibration is transmitted through the connector 510, since the buffer column 260 is sleeved on the connector 510, the vibration on the connector 510 is transmitted radially to the buffer column 260, and the buffer column 260 subsequently radially transmits the vibration to the partition plate 230 (into which the buffer column 260 is inserted), the second buffer plate 250 (to which the buffer column 260 is connected), and the end cover module 560 (into which the buffer column 260 is inserted). Thus, the partition plate 230, the second buffer plate 250, the end cover module 560, and the buffer column 260 simultaneously transmit the vibration axially and radially, When different directions of vibrations are transmitted within the same part, the vibration reduction effect is significantly improved.

In some embodiments, to further improve the buffering effect, the partition plate assembly 230 further includes a first buffer plate 220 located between the partition plate 230 and the massage head 100. Both the first buffer plate 220 and the second buffer plate 250 are made of soft rubber material, and the partition plate 230 is made of rigid material. In this embodiment, the partition plate 230 is rigid such that the first buffer plate 220 can be clamped between the rigid massage head 100 and the partition plate 230 and the second buffer plate 250 can be clamped between the hard partition plate 230 and the rigid end cover 520, which can effectively enables the buffer assembly 200 to relieve and reduce the vibrations. Furthermore, a rigidity of the buffer assembly 200 can be ensured to prevent excessive a deformation of the massage head 100 during the vibration and thus prevent a large-amplitude deflection of the massage head 100, which allows for a balance between the vibration reduction effect of the handheld assembly 300 and the operational stability of the massage device.

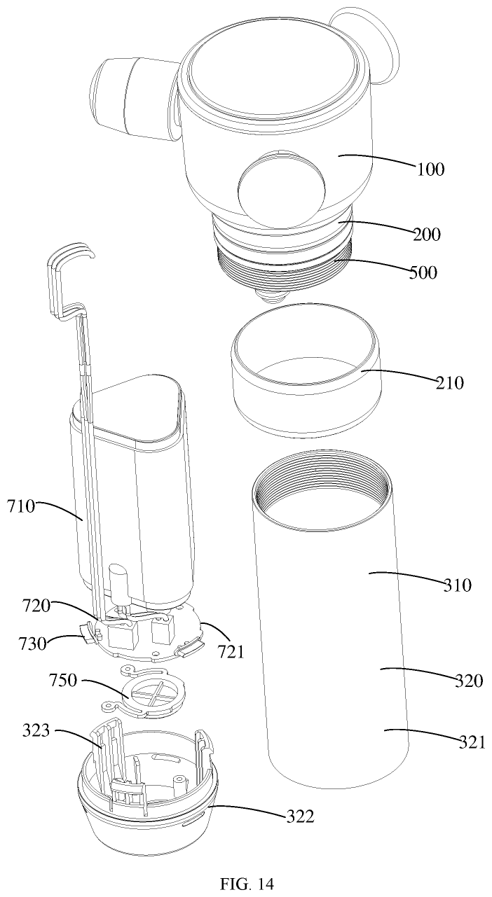

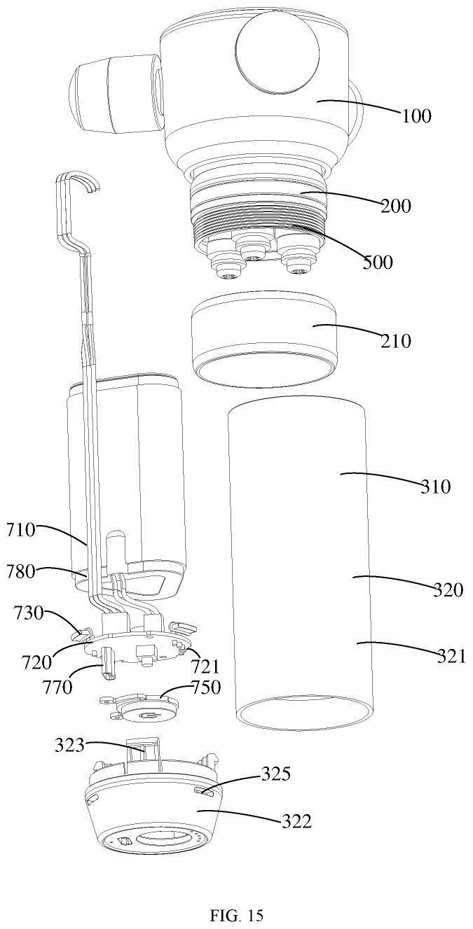

In some embodiments, as shown in FIGS. 14 and 15, this application further provides a massage device to improve the using safety of the massage device. The massage device includes a massage head 100, a detection component, an indicator light 730, and a main control board 720.

The massage head 100 has at least one massage surface and an assembly space. Within the assembly space, a vibration generator is fixed to the massage head for causing the massage head 100 to vibrate. The detection component is configured to detect a current/voltage of the vibration generator. Both the indicator light 730 and the detection component are electrically connected to the main control board 720, and the main control board 720 is configured to trigger the operation of the indicator light 730 based on a magnitude of the current/voltage detected by the detection component.

In this embodiment, the vibration generator includes an electric motor 600 and an eccentric member 680. The electric motor 600 includes a stator 615, a rotor, and an output shaft 620. The stator 615 is fixed to the massage head 100, the rotor is rotatable relative to the stator 615, and the output shaft 620 is fixed to the rotor. The eccentric member 680 is fixed to the output shaft 620 to eccentrically rotate with the output shaft 620 such that the eccentric member 680 can covert a rotation output by the electric motor 600 into a vibration in the massage head 100. The detection component can be a current/voltage sensor to detect the current/voltage of the vibration generator, that is, to detect the current/voltage of the electric motor 600. The indicator light 730 can have various forms, such as an LED. The main control board 720 can be a rigid or flexible circuit board. The indicator light 730 can be electrically connected to the detection component in various ways, for example, the indicator light 730 can be connected to the detection component through an electrical connector (like a wire or a flexible circuit board) or mounted onto the main control board 720 directly, in which pins of the indicator light 730 are directly welded to the main control board 720. The main control board 720 can trigger the operation of the indicator light 730 based on the detected current/voltage from the detection component in various ways. Here is an illustrative example below. The main control board 720 includes a trigger circuit. The detection component converts the detected current/voltage into an electrical signal, which is input to the trigger circuit. When a strength of the electrical signal is greater than a threshold of the trigger circuit, the electrical signal triggers the indicator light 730 to cause a change of the indicator light 730. The change of the indicator light 730 includes a change from an off state to an on state, or a change of a color emitted by the indicator light 730, which can be considered as a reminder to the user. When the strength of the signal strength is less than the threshold of the trigger circuit, the indicator light 730 remains unchanged in the current state.

During the operation of the massage device, the greater the current/voltage passing through the electric motor, the stronger the vibration of the massage head 100. In this embodiment, with the vibration generator arranged in the massage head 100, the detection component configured to detect the current/voltage of the vibration generator, and the main control board 720 which can trigger the indicator light 730 based on the detected current/voltage, when the current/voltage is greater than the threshold, the main control board 720 triggers the indicator light 730 to cause a change of the indicator light 730, which is used as a reminder to the user about the current vibration intensity level of the massage head 100. This avoids skin damage due to the longtime vibration from the massage head 100 caused by overestimating of the vibration intensity by the user, and the using safety of the massage device is thus improved.

In some embodiments, in order to indicate the current vibration intensity, a trigger circuit is arranged on the main control board 720. The circuit includes a first trigger threshold and a second trigger threshold greater than the first trigger threshold. When the current/voltage in the vibration generator is greater than or equal to the first trigger threshold, the trigger circuit triggers the indicator light 730 and the indicator light emits a first color; when the current/voltage is greater than or equal to the second trigger threshold, the trigger circuit triggers the indicator light 730 and the indicator light 730 emits a second color. In detail, the trigger circuit has the first trigger threshold and the second trigger threshold different from the first trigger threshold. When a strength of an electrical signal from the detection component is greater than the first trigger threshold, the indicator light 730 is triggered and the first color is emitted, indicating that the vibration intensity of the massage head 100 has reached a considerable level. When the strength of the electrical signal is greater than the second trigger threshold, the indicator light 730 emits the second color, indicating that the vibration intensity has reached a high level and the user needs to pay more attention. The first and second colors can have different forms, and an example is provided below for illustration. Upon powering on, the indicator light 730 initially emits a green color; when the current/voltage of the electric motor 600 reaches the first trigger threshold, the indicator light 730 turns yellow; when the current/voltage reaches the second trigger threshold, the indicator light 730 becomes red. More levels of the threshold can be implemented, such as setting a third trigger threshold. Since the indicator light 730 can emit various colors in response to different trigger thresholds, enabling the user to clearly discern the current vibration intensity level of the massage device and preventing potential skin damage due to longtime high-intensity vibration.

In some embodiments, to improve the structural compactness, the massage device includes a handheld assembly 300 having a head portion and a rear portion. The massage head 100 is located on the head portion. The handheld assembly 300 includes a outer shell 320, in which the main control board 720 is arranged. A mounting hole 325 is defined in a sidewall of the outer shell 320 adjacent to the main control board 720, and the indicator light 730 is arranged in the mounting hole. In this embodiment, multiple indicator lights 730 are configured and are distributed along a circumferential direction of the outer shell 320, allowing the indicator lights 730 to be seen from different angles. Since the mounting hole 325 is close to the main control board 720, a distance between the indicator light 730 and the main control board 720 is greatly reduced to facilitate the connection between the indicator light 730 and the main control board 720. The main control board 720 is arranged radially along the outer shell 320, that is, the main control board 720 is parallel with a cross section of the outer shell 320, which allows the indicator lights 730 to be arranged at intervals along the circumferential direction of the main control board 720 by being mounted into the mounting holes 325.

In some embodiments, the massage device further includes a control button 750 located on the rear portion and is exposed on an end surface of the rear portion. The main control board 720 is adjacent to the rear portion and is parallel with the end surface of the rear portion. A trigger unit engaging with control button 750 is arranged on a board surface of the main control board 720 that faces the control button 750. The control button 750 can have various forms, such as a power button. A trigger element is arranged on the board surface of the main control board 720 facing the rear portion; when the control button 750 is pressed to trigger the trigger element, the trigger element outputs the electrical signal to the main control board 720. Since the control button 750 is arranged on the end surface of the rear portion, accidental pressing of the control button 750 can be avoided and the operational stability of the massage device can be thus improved.

In some embodiments, for improving the convenience of assembling the massage device, the outer shell 320 includes a middle shell 321 and a rear shell 322. The rear shell 322 is detachably connected to an end of the middle shell 321 away from the massage head 100. The main control board 720 is located in the rear shell 322, the mounting holes 325 are defined in a peripheral sidewall of the rear shell 322, and the control button 750 are located in the rear shell 322, extending out of the end surface of the rear shell 322 that faces away from the middle shell 321. The outer shell 320 can be connected to the rear shell 322 in various ways, such as using buckles or fasteners like screws. Since the main control board 720 is arranged in the rear shell 322, the control button 750 is arranged on the end surface of the rear shell 322, and the indicator light 730 is arranged on the sidewall of the rear shell 322, the components in the rear shell 322 and the components in the middle shell 321 can be respectively independently assembled, and then the middle shell 321 and the rear shell 322 are assembled together, which allows for the synchronous assembly of the middle shell 321 and the rear shell 322 and results in a more efficient assembly process. In some embodiments, to improve the convenience of the massage device, a charging hole is defined in the end surface of the rear portion, and a charging connector 770 is embedded on the main control board 720 corresponding to the charging hole. The charging connector 770 extends to the charging hole and is exposed through the charging hole. With the charging hole and the charging connector 770, a battery 710 of the massage device can be charged in time, thereby extending an endurance of the massage device. Meanwhile, since the charging hole is defined in the end surface, the charging cable can be inserted into the charging hole easily and accidental touch during use may not easily occur to prevent potential damage.

In some embodiments, to reduce the vibration of the handheld assembly 300, the massage device includes a damping balance block 780. The handheld assembly 300 includes an outer shell 320, within which the damping balance block 780 is arranged. The damping balance block 780 is configured to reduce the vibration of the handheld assembly 300.

In this embodiment, the damping balance block 780 can have various shapes, such as shaped as a flat block. The damping balance block 780 can be made of a variety of materials which can effectively increase a weight thereof, including metal, ceramic, and etc. The damping balance block 780 can be mounted in the outer shell 320 in various ways, for example, the damping balance block 780 can be directly fixed to the inner sidewall of the outer shell 320 or fixed to components arranged in the outer shell 320, such as an end of the battery 710. When the massage head 100 transmits the vibration to the handheld assembly 300 and thus causes the handheld assembly 300 to vibrate, an amplitude of the vibration in the handheld assembly 300 is influenced by the weight of the handheld assembly 300. Given the same received vibration, the greater the weight of the handheld assembly 300 is, the smaller the vibration of the handheld assembly is. With the damping balance block 780, the weight of the handheld assembly 300 can be increased to provide a greater damping effect for vibration, thereby reducing the vibration in the handheld assembly 300. In some embodiments, the power supply is arranged in the outer shell 320 which is electrically connected to the main control board 720 and the vibration generator. The main control board 720 is located at the end of the power supply away from the massage head 100, and the damping balance block 780 is located between the power supply and the main control board 720, thus, the damping balance block 780 can be mounted easily without affecting the installation of the main control board 720. In some embodiments, the damping balance block 780 is connected to the end of the power supply adjacent to the main control board 720. An isolation gap being larger than 8 mm is formed between the damping balance block 780 and the main control board 720. With the isolation gap, potential safety risks such as leakages between the main control board 720 and the damping balance block 780 can be avoided. Since the isolation gap is greater than 8 mm, that is, the isolation gap is greater than the creepage distance between the main control board 720 and the damping balance block 780, the safety of the massage device can be thus improved.

In some embodiments, the outer shell 320 includes a middle shell 321 and a rear shell 322 detachably connected to an end of the middle shell 321 away from the massage head 100. The main control board 720 is located in the rear shell 322. The rear shell 322 and the middle shell 321 are connected through a buckle structure 323. An avoidance gap 721 is formed in the damping balance block 780 to avoid the buckle structure 323. In this embodiment, the rear shell 322 is connected to the middle shell 321 through buckles. The buckle structure 323 is located in the rear shell 322 such that the buckles can be covered by the middle shell 321 after assembly to prevented from being exposed outside. The avoidance gap 721 is arranged at edges of the main control board 720 and the damping balance block 780 to avoid the buckle structure 323, thus, the main control board 720 and the damping balance block 780 may not affect the connection between the rear shell 322 and the middle shell 321 even when being configured with a substantial cross section respectively, which utilizes the available space and improves the structural compactness. In some embodiments, the buckle structure 323 can abut a sidewall of the avoidance gap 721, thereby applying a certain force onto the main control board 720 and the damping balance block 780, which improves the stability of the installation of both the main control board 720 and the damping balance block 780.

The above descriptions are only optional embodiments of the application, and do not limit the scope of the patents of the present application. All the equivalent structural transformations made by the content of the specification and drawings of the present application under the creative concept of the present application, or directly/indirectly used in other related technical fields are all included in the protection scope of the patents of the present application.

What is claimed is:

1. A massage device, comprising:
a massage head having at least one massage surface and an assembly space;
a mounting bracket mounted in the assembly space and fixed to the massage head;
an electric motor and an eccentric member arranged in the assembly space and located on opposite sides of the mounting bracket;
a balancing member located on the same side of the mounting bracket as the electric motor;
wherein the electric motor comprises a stator, a rotor, and an output shaft; the stator is fixed to the mounting bracket, the rotor is rotatable relative to the stator, and the output shaft is fixed to the rotor and is rotatably connected to the mounting bracket;
the eccentric member is fixed to the output shaft to rotate eccentrically with the output shaft, and is configured to convert a rotation output by the electric motor into a vibration of the massage head; and
the balancing member is connected to the rotor or the output shaft such that the balancing member is capable of rotating with the rotor or the output shaft; and the balancing member is configured to increase a weight of the rotor or an end of the output shaft away from the eccentric member to balance two sides of the mounting bracket, such that the eccentric member, the output shaft, the rotor, and the balancing member are capable of respectively performing a balanced circular rotation to prevent any deflection of the two ends of the output shaft.

2. The massage device according to claim 1, wherein the mounting bracket is located in an assembly chamber defined in the assembly space along a radial direction of the output shaft to divide the assembly chamber into a first chamber and a second chamber arranged along an axial direction of the output shaft;
the eccentric member is located in the first chamber, the stator, the rotor, and the balancing member are located in the second chamber, and the output shaft extends from the second chamber into the first chamber; and
the mounting bracket is plate-shaped, and both the eccentric member and the balancing member are symmetrical about the mounting bracket.

3. The massage device according to claim 1, wherein the electric motor is an inner rotor motor having an inner rotor, and the balancing member is arranged on the inner rotor; and/or,
one end of the output shaft away from the eccentric member extends out of the stator and the rotor, and the balancing member is arranged on the end of the output shaft away from the eccentric member.

4. The massage device according to claim 1, wherein the electric motor is an outer rotor motor having an outer rotor, the outer rotor comprises a rotary cylinder having an annular sidewall and an end wall arranged on one end of the sidewall, and the balancing member is arranged on the sidewall and/or the end wall; and
the stator is located in the rotary cylinder and is fixed to the mounting bracket.

5. The massage device according to claim 1, wherein a weight of the eccentric member ranges from 11 g to 45 g, and a weight of the balancing member ranges from 4 g to 11 g;
a ratio of a distance between an outer edge of the eccentric member and the output shaft to a distance between an outer edge of the balancing member and the output shaft ranges from 0.8 to 1.2; and/or,
the distance between the outer edge of the eccentric member and the output shaft ranges from 16 mm to 26 mm, and similarly, the distance between the outer edge of the balancing member and the output shaft also ranges from 16 mm to 26 mm.

6. The massage device according to claim 1, wherein both the eccentric member and the balancing member are located on the same side of the output shaft; the eccentric member comprises a first symmetrical plane in parallel with the output shaft, the balancing member comprises a second symmetrical plane in parallel with the output shaft, and an angle formed between the first symmetrical plane and the second symmetrical planes is less than 10°.

7. The massage device according to claim 1, wherein the massage head comprises a shell portion and a massage portion arranged on an outer sidewall of the shell, the massage portion has the massage surface; the shell portion forms the assembly space, and the mounting bracket is fixed to an inner sidewall of the assembly space at a position corresponding to the massage portion.

8. The massage device according to claim 7, wherein the massage device comprises multiple massage portions arranged on the massage head at intervals around a circumferential direction of the shell portion; the mounting bracket comprises a bracket body and several mounting portions, the mounting portions are arranged at intervals along a circumferential direction of the bracket body, and the mounting portions are connected to the shell at a position corresponding to the massage portion.

9. The massage device according to claim 1, further comprising a handheld assembly configured to be held by an user;
a buffer assembly configured to reduce a vibration transmission between the massage head and the handheld assembly; the buffer assembly being elastic or flexible, one end of the buffer assembly abutting the end of the massage head, the other end thereof being connected to the handheld assembly; and
a connecting assembly configured to connect the handheld assembly and the massage head to clamp the buffer assembly between the massage head and the handheld assembly; the handheld assembly comprising at least one strip-shaped connector made of rigid material, one end of the connector directly or indirectly being connected to the handheld assembly, and the other end thereof passing through the buffer assembly to be fixed to the massage head via the buffer assembly.

10. The massage device according to claim 9, wherein the connecting assembly further comprises an end cover module, the handheld assembly comprises a handheld tube, the end cover module is fixed to an end of the handheld tube; one end of the connector is connected to the massage head, and the other end thereof engaging with the end cover module; and
the end cover module comprises a through hole, the connector comprises a limiting end and a connecting end; the connecting end is configured to be fixed to the massage head through the through hole; a radial size of the limiting end is larger than that of the through hole; the limiting end is configured to abut the side of the end cover module facing away from the massage head when the connecting end is fastened to the massage head.

11. The massage device according to claim 9, wherein the connecting assembly further comprises an end cover module, the handheld assembly comprises a handheld tube; the end cover module is fixed to one end of the end cover module, one end of the connector is connected to the massage head, and the other end thereof engages with the end cover module; and
the end cover module comprises an end cover and a buffer column; the end cover is configured to be connected to the handheld tube, the buffer column is mounted on the end cover, and one end of the buffer column abuts the buffer assembly to reduce a vibration transmission between the buffer assembly and the end cover.

12. The massage device according to claim 11, wherein the buffer column comprises a first through hole, the buffer column is sleeved on the connector and is tightly engaged with the connector to reduce the vibration transmission between the connector and the end cover.

13. The massage device according to claim 9, wherein the buffer assembly comprises a buffer plate assembly, one end of the buffer plate assembly abuts the end of the massage head, and the other end thereof abuts the connector;
the connector comprises an end cover module fixed to an end of the handheld assembly;
one end of the connector is connected to the massage head, and the other end thereof engages with the end cover module; and
the buffer plate assembly is clamped between the end cover module and the massage head to reduce a vibration transmission between the massage head and the end cover module.

14. The massage device according to claim 13, wherein one side of the buffer plate assembly facing the massage head comprises a first insertion socket, a connecting column is arranged on one end of the massage head facing the buffer plate assembly, the connecting column is inserted into the first insertion socket;
one side of the buffer plate assembly facing the end cover module comprises a second insertion socket; the end cover module comprises an end cover and a buffer column mounted on the end cover, one end of the buffer column is exposed on the end cover and is inserted into the second insertion socket; and
the first insertion socket and the second insertion sockets are coaxial and communicated with each other.

15. The massage device according to claim 13, wherein the buffer plate assembly comprises a partition plate and a second buffer plate located between the partition plate and the end cover module, a buffer column is arranged on the second buffer plate extending along a thickness direction of the second buffer plate;
one the side of the partition plate facing the second buffer plate comprises a first insertion socket, and one end of the buffer column is inserted into this first insertion socket; one side of the end cover module facing the second buffer plate comprises a second insertion socket, and one end of the buffer column away from the partition plate is inserted into the second insertion socket; and
the first insertion socket passes through the partition plate, the second insertion socket passes through the end cover module, and the buffer column comprises a first through hole running through a lengthwise direction thereof, the connector passes through the first through hole, the first insertion socket, and the second insertion socket to be fixed to the massage head, to reduce a vibration transmission between the connector, the end cover, and the partition plate.

16. The massage device according to claim 15, wherein the buffer assembly comprises a first buffer plate located between the partition plate and the massage head, both the first buffer plate and the second buffer plate are soft rubber plate, while the partition plate is a rigid plate; and/or,
the buffer column and the second buffer plate are integrally formed; and/or,
the buffer column is elastic, one end of the buffer column engaging with the end cover module extends out of the second insertion socket; two ends of the connector comprise a limiting end and a connecting end, the connecting end is configured to be fixed to the massage head, and the limiting end is configured to abut the end of the buffer column extending out of the second insertion socket.

17. The massage device according to claim 1, further comprising:
a vibration generator mounted in the assembly space comprising the electric motor;
a detection component configured to detect a current/voltage of the vibration generator; and
an indicator light and a main control board, wherein the indicator light and the detection component are electrically connected to the main control board, and the main control board is configured to trigger the indicator light based on the current/voltage detected by the detection component.

18. The massage device according to claim 17, wherein the massage device comprises a handheld assembly having a head portion and a rear portion, the massage head is located on the head portion;
the handheld assembly comprises a shell, which comprises a middle shell and a rear shell, and the rear shell is detachably connected to an end of the middle shell away from the massage head;
the massage device comprises a control button, and a trigger unit corresponding to the control button is arranged on one side of the main control board that faces the control button; and
the main control board is located in the rear shell, a peripheral sidewall of the rear shell defines a mounting hole in which the indicator light is mounted; the control button is mounted in the rear shell and is exposed on an end surface of the rear shell facing away from the middle shell.

19. The massage device according to claim 17, wherein the main control board comprises a trigger circuit, which comprises a first trigger threshold and a second trigger threshold greater than the first trigger threshold; and
the trigger circuit is configured to trigger the indicator light to emit a first color when the current/voltage in the vibration generator is equal to or greater than the first trigger threshold, and to trigger the indicator light to emit a second color when the current/voltage in the vibration generator is equal to or greater than the second trigger threshold.

20. The massage device according to claim 17, wherein the massage device comprises a damping balance block and a handheld assembly, the handheld assembly comprises an outer shell in which the damping balance block is arranged, the damping balance block is configured to reduce the vibration of the handheld assembly.
